(19) United States
(12) Patent Application Publication
(10) Pub. No.: US 2008/0138087 A1
(43) Pub. Date: Jun. 12, 2008

(54) Optical quantum information transfer device

(76) Inventor: Douglas Michael Snyder, Los Angeles, CA (US)

Correspondence Address: Douglas M. Snyder, P.O. Box 551, Beverly Hills, CA, 90213, US

(21) Appl. No.: 11/803,879

(22) Filed: May 16, 2007

Related U.S. Application Data
(60) Provisional application No. 60/874,435, filed on Dec. 11, 2006.

(51) Int. Cl. H04B 10/04

(52) U.S. Cl. 398/182

(57) ABSTRACT

Binary information can be sent between locations remote from one another in part without the limitation of the velocity of light in vacuum. The OQITD relies on “hidden” events for idler photons traveling through an interferometer where these “hidden” events point to which-way information for these photons. Through either: 1) keeping the “hidden” events “hidden” until potential which-way information is lost, or 2) making these events public before potential which-way information is lost, one can influence the overall spatial distribution of distant paired signal photons that were created in the same process and location as the idler photons and which travel in a different direction than the idler photons. Two possible overall distributions for the signal photons can be developed in different sets of runs. One distribution indicates which-way information concerning the idler photons, and the other distribution indicates interference. These different distributions can be used to create binary bits.

### CROSS-REFERENCE TO RELATED APPLICATIONS

Application for Provisional Patent filed by Douglas Michael Snyder for Optical Quantum Information Transfer Device (OQITD) [Application Number US60/874,435], filed Dec. 11, 2006.

Application for Non-Provisional Patent filed by Douglas Michael Snyder for Quantum Information Transmission Device (QITD) [application Ser. No. 11/348,061], filed Feb. 6, 2006.

### STATEMENT REGARDING FEDERALLY SPONSORED RESEARCH OR DEVELOPMENT

Not Applicable

### REFERENCE TO SEQUENCE LISTING,

### A TABLE, OR A COMPUTER PROGRAM

### LISTING COMPACT DISK APPENDIX

Not Applicable

### BACKGROUND OF THE INVENTION

The field of endeavor to which the invention pertains is physics.

No relevant patents found.

Following is a description of information known to me that is related to my invention. Also, this description references specific problems involved in the prior art (and accompanying technology) to which my invention is drawn.

Scully, Englert, and Walther adapted the classic double-slit experiment in quantum mechanics, examples of which have been described by Bohr and Feynman, to demonstrate the quantum eraser effect (FIG. 1).^{1,2,3} As seen in FIG. 1, the micromaser cavity system is physically separated from the double-slit screen where traditionally interference or the lack thereof is considered to develop due to whether or not the screen is fixed or instead, for example, on rollers.² In the classic double-slit experiment where the double-slit screen is fixed in place, one obtains interference with the passage of particles through it (FIG. 2). In the classic double-slit experiment, the wave function for the particle passing through the double-slit screen is:

Ψₜₒₜₐₗ=1/√2[ψ_{L}+ψ_{R}], [1]

where ψ_{L} and ψ_{R} represent the component wave functions associated with slits L and R. The distribution at the detection screen demonstrates interference and is given by P where:

P=|Ψₜₒₜₐₗ|²=½[|_{L}|²+|ψ_{R}|I²+ψ_{L}*ψ_{R}+ψ_{R}*ψ_{L}]. [2]

If, on the other hand, the screen is placed on rollers, one loses interference and obtains which-way information concerning the passage of the particles through the double-slit screen (FIG. 3).^{A} The wave function for the particle when the double-slit screen on rollers is either:

Ψ_{particle}=ψ_{L} [3a]

or

Ψ_{particle}=ψ_{R} [3b]

The distribution at the detection screen does not demonstrate interference and is given by P where:

P=|ψ_{L}|²+|ψ_{R}|². [4]

By physically separating the micromaser cavity system from the double-slit screen, Scully, Englert, and Walther showed that a change from interference to which-way information for atoms passing through the double-slit screen was not dependent on a distinct physical interaction between the atoms and the double-slit screen occurring as the atoms pass through it.^{B} The double-slit screen was always fixed in place in their experiment. Moreover, they demonstrated that the atoms passing through the micromaser cavity system were unaffected in their motion by their passage through the micromaser cavity system with regard to any variable involving their motion that could alter their interaction with the double-slit screen from what it would have been had there been no micromaser cavity system in the experiment.^{C}

Instead, whatever change happened at the double-slit screen was due to an effect of the atoms' passage through the micromaser cavity system that did not affect any relevant variables of their motion. This effect concerned an atom's spontaneously emitting a photon into one of the two micromaser cavities comprising the micromaser cavity system that at first does not contain any photons.^{D} The presence of this photon emitted by an atom in one or the other of the micromaser cavities provided the possibility of obtaining which-way information concerning the specific path of the atom through the cavity system should the measurement of the photon's specific location in one or the other of the micromaser cavities be made. When the photon is emitted by the atom, it is only known that the photon is in one or the other of the micromaser cavities. It is not known, though, into which specific micromaser cavity the photon was emitted. The atom's emission of a photon into one of the two micromaser cavities was a measurement of the location of the photon even though it did not provide information as to the specific micromaser cavity into which the atom emitted the photon.

Scully and his colleagues attempted to show that complementarity and not the uncertainty principle, which they maintained involved a physical interaction between the atom and the double-slit screen through which it passed, was responsible for the development, or absence, of interference. The double-slit screen retained its capacity to demonstrate interference or the lack thereof, but now this capacity was tied to what occurred with the atom's passage through the micromaser cavity system.^{E} In other words, the wave functions of the photon emitted in the micromaser cavity system and the atom passing through the double-slit screen were now entangled. A one-to-one correspondence developed between the photon emitted by an atom into a specific micromaser cavity and the atom's subsequent passage through a specific slit in the double-slit screen. Importantly, this entanglement occurred over time, specifically between the time the atom emitted the photon in one of the micromaser cavities and the time that the atom subsequently traveled through the double-slit screen. It should be noted that before the atom passing through the micromaser cavity system emitted a photon in the micromaser cavity system, there were no photons present in the cavity system.

With the laser, micromaser cavities, shutters, and photodetector enabled and before the shutters are opened and the photodetector exposed, the wave function for the atom and the emitted photon after the atom exits the micromaser cavities and before it reaches the double-slit becomes:

Ψₜₒₜₐₗ=1/√2[ψ_{L}|1_{L}0_{R}>+ψ_{R}|0_{L}1_{R}>]|b> [5]

where b is the internal state of the atom after it emits a photon, |1_{L}0_{R}> represents the state where a photon is in cavity L and is not in cavity R, and |0_{L}1_{R}> represents the state where a photon is in cavity R and is not in cavity L.^{F} The probability distribution is given by:

P=|Ψₜₒₜₐₗ|²=½[|ψ_{L}|²+|ψ_{R}|²+ψ_{L}*ψ_{R}<1_{L}0_{R}|0_{L}1_{R}>+ψ_{R}*ψ_{L}<0_{L}1_{R}|1_{L}0_{R}>]<b|b>.

The photon-cavity terms equal 0 due to their orthogonality and:

P=|Ψₜₒₜₐₗ|²=½[|ψ_{L}|²+|ψ_{R}²]<b|b> [6]

### Eqn. 6 is similar to eqn. 4, and the shape of the distribution of the atoms like that in FIG. 3, namely the one broad hump characteristic of which-way information.

Scully and his colleagues went on to show that after the atom went through the double-slit screen and the entanglement was established, one could obtain sub-interference patterns of the particle at the detection screen (depicted in FIG. 1) through opening up shutters separating the micromaser cavities and exposing a photodetector that could detect the presence of the emitted photon. The sum of these sub-interference patterns remained the one broad hump distribution characteristic of the loss of interference and the presence of which-way information (like the distribution in FIG. 3). They called their method of obtaining these sub-interference patterns quantum erasure.^{G} Experiments involving quantum erasers provide support for their predictions.^{4,5}

Scully and his colleagues converted the wave function in their experiment (eqn. 1) to one expressed in terms of symmetric and anti-symmetric wave functions. They defined symmetric and anti-symmetric atomic states and states of the radiation fields inside the micromaser cavities:

ψ_{S}=1/√2[ψ_{L}+[ψ_{R}] [7]

ψ_{A}=1/√2[ψ_{L}−[ψ_{R}] [8]

|1_{S},0_{A}>=1/√2[|1_{L}0_{R}>+|0_{L}1_{R}>] [9]

|0_{S},1_{A}>=1/√2[|1_{L}0_{R}>−|0_{L}1_{R}>] [10]

The converted wave function is:

Ψₜₒₜₐₗ=1/√2[ψ_{S}|1_{S},0_{A}>+ψ_{A}|0_{S},1_{A}>]|b> [11]

|ψ_{S}(r)|1_{S},0_{A}> represents the state where the photon will be detected by the photodetector when the two shutters are opened and the photodetector exposed, and |ψ_{A}|0_{S},1_{A}> represents the state where the photon will not be detected by the photodetector. The probability of each occurring is ½. With the opening of the shutters, the exposure of the photodetector, and the overlap of the component wave functions for the single photon, the converted wave function becomes the appropriate wave function for describing the system of the atom and photon. The converted wave function provides a good description of the measurement possibilities regarding the photon when the shutters are opened and the photodetector exposed.

It was noted that the sum of these sub-interference patterns obtained by Scully and his colleagues remained the one broad hump distribution characteristic of the loss of interference and the presence of which-way information (like the distribution in FIG. 3). In order to obtain the sub-interference patterns one had to correlate: 1) the specific event that occurred when the shutters between the two micromaser cavities were opened and the photodetector exposed (whether the photon that had been located in one of the two micromaser cavities was or was not detected by the photodetector), and 2) the detection of the atom associated with the photon at the detection screen. The correlations cannot be developed until both events 1 and 2 have occurred. In their experiment, it was not possible to use the sub-interference patterns to send information from the site of the micromaser cavities to near the site of the detection screen for the atoms by locating the double-slit screen near the site of the detection screen.

Kim and his colleagues⁴ performed a novel form of quantum eraser experiment that incorporated the same fundamentals as those discussed above for the experiment by Scully and his colleagues. Kim and his colleagues used a device that could act as an interferometer with two possible photon sources in place of the photon emitted in the micromaser cavity system by an atom passing through the cavity system (FIG. 4). (Besides functioning as an interferometer, Kim and his colleagues also used this apparatus so that one-half of the photons passing through the first part of the device, specifically that part of the device from M to Y or Z, provide which-way information regarding the path of the photon through the device. They accomplished this through the use of beam splitters instead of full-silvered mirrors at Y and Z. In their experiment, ½ of the generated signal photons traveled through the beam splitters at Y and Z instead of being reflected at Y and Z toward the beam splitter BS at N.) Kim and his colleagues used spontaneous parametric down conversion (SPDC) to create the signal-idler photon pairs.

Instead of the atom that emits a photon in one or the other of the micromaser cavities as in the Scully experiment, Kim and his colleagues entangled the photon moving through the interferometer (the idler photon) with a second paired photon (the signal photon) generated in the same process at a single location (i.e., one of two possible sources for the signal-idler photon pair). The signal photon travels away from the interferometer and impacts a detection apparatus that detects the location of this photon along a spatial axis approximately perpendicular to the direction of travel of this photon. For the idler photons traveling through the beam splitters at Y or Z (i.e., BS_Y or BS_Z), the distributions of the signal photons correlated with their respective entangled idler photons each showed the one broad hump characteristic of which-way information.^{H} (Both distributions had the shape of the distribution in FIG. 3.)

For the ½ of the generated idler photons that are reflected at the beam splitters at Y and Z toward BS at N and that are subsequently detected at detectors D1 or D2 (¼ of the generated idler photons are detected at D1 and ¼ of the generated idler photons are detected at D2), the distributions of the paired signal photons detected along a spatial axis are two narrow multiple hump sub-distributions that indicate the presence of interference (i.e., fringes and anti-fringes) when the signal photon detections are correlated with the idler photon detections. The fringes and anti-fringes sub-distributions summed to the one wide hump characteristic of which-way information. These fringes and anti-fringes indicate the loss of which-way information concerning the path of the paired idler photon that passes through, or is reflected from, BS at N. This which-way information concerning the path of the idler photon through the interferometer until BS at N stemmed from the origin of the idler photon (as well as for the entangled signal photon) at a specific photon source of the two possible photon sources where the signal-idler photon pair could be generated. That is, initially each path through the interferometer was associated with a specific photon source. This association was lost with the passage of the idler photon through BS at N.

It should be noted that specific which-way information is not provided in the Kim experiment by the trajectory of the signal photon itself traveling away from the interferometer and toward the spatial axis where its location is detected. Shortly after this photon is generated and is on its way to the detection axis, the use of a lens in the possible paths of the signal photons focuses both possible paths in such a way that one cannot detect the specific trajectory of the signal photon to the spatial axis where its location is determined along this axis (the far field effect). In the far field effect, the two possible trajectories of the signal photon cannot be discriminated from one another, and thus the specific photon source at the origin of each trajectory cannot be determined. Since SPDC, the process used to create the signal-idler photon pairs, conserves energy and momentum, the crystal where the signal-idler photon pair is created does not change as a result of the creation process. Thus, the physical process of creating the signal-idler photon pair at a source does not itself provide which-way information concerning the path of the idler photon through the interferometer.^{6,7}

General which-way information could be provided in the brief time before the far field effect is achieved. The signal photon remains entangled with the paired idler photon, and thus the distribution of the signal photons along the detection axis in the overall and the sub-distributions of the signal photons (the sub-distributions being the fringes and anti-fringes) reflect the status of which-way information concerning the paired idler photons as these idler photons travel through the interferometer. In Kim's experiment, the overall distribution of the signal photons reflects the fact that general which-way information concerning the idler photons was once publicly available, even though this general which-way information was subsequently lost with the passage of the idler photons through BS at N.

More specifically, in Kim and his colleagues' device, a photon initially originates from one of the photon sources A or B as part of an entangled signal-idler photon pair and travels along one arm of the interferometer until it reaches Y or Z. There are beam splitters at Y and Z (i.e., BS_Y or BS_Z). If the photon passes through BS_Y or BS_Z and passes on to a detector, specific which-way information is obtained regarding the path of the photon in that the specific path of the idler photon has been determined. The operation of the device as an interferometer is interrupted with this result. If, on the other hand, the photon is reflected at BS_Y or BS_Z and travels on to the beam splitter BS at N, the photon either passing through BS, or reflected at BS, results in the loss of which-way information which had existed previously to the photon's reaching BS. It can no longer be determined whether the photon originated at A or B.

The sub-interference patterns obtained by Kim and his colleagues add to the one wide hump just as in the experiment by Scully and his colleagues (FIG. 1) because which-way information was available in the Kim experiment until the photon traveling through the interferometer reached the beam splitter. The paths from M to N are not “hidden” by a shielding enclosure.^{I} In support of this idea that which-way information was available during the period indicated, an idler photon was detected in detectors D3 or D4 for each of the idler photons passing through the beam splitters at Y or Z (i.e., BS_Y or BS_Z) and each of the two distributions of the signal photons entangled with their respective idler photons detected at detectors D3 or D4 was the one wide hump indicative of which-way information.

As noted, this combination of a general distribution showing which-way information that was at some point available to the environment and sub-distributions within this general distribution, each sub-distribution reflecting the presence of interference, are found in the specific scenarios of Scully and his colleagues and by Kim and his colleagues.^{1,4} So in the experiment by Scully and his colleagues, the two sub-distributions of atoms detected at the detection screen (i.e., fringe and anti-fringe distributions), when correlated either with or without the erasure of the paired emitted photons, sum to the one wide hump characteristic of which-way information. In the experiment by Kim and his colleagues, for those photon pairs where the idler photon was reflected off B_Y and B_Z, the distribution of the paired signal photons along a spatial axis shows the overall one wide hump distribution characteristic of which-way information. Within this overall distribution are two sub-distributions of the signal photon detections (when correlated with the paired idler photon detections) showing interference (through symmetric and anti-symmetric wave components) which reflects the loss of which-way information with the passage of the paired idler photons through BS.

### Quantum Information Transmission Device (QITD)⁸

Consider the situation where the scenario proposed by Scully and his colleagues¹ is changed so that there is no photodetector and the single shutter between the micromaser cavities is opened before the atom reaches the double-slit screen (FIGS. 5, 6).^{J} In this case, the entanglement between the photon's being emitted in a specific micromaser cavity and the atom's subsequent passage through a specific slit has not been established. The photon is hidden in the micromaser cavity system (i.e., shielded by the micromaser cavity system) so information is not available from the photon itself as regards the specific micromaser cavity into which the photon was initially emitted by the atom. Also, the atom's motion is not changed by emitting the photon in a specific micromaser cavity, and therefore one cannot determine from the motion of the atom into which specific micromaser cavity the photon was initially emitted.

What happens is that the two wave function components for the photon in the micromaser cavity system (|1_{L}0_{R}> and |0_{L}1_{R}>) that at first represent the possibilities of the photon's being in either one or the other of the micromaser cavities come to overlap in the one expanded micromaser cavity. Very importantly, these wave functions maintain their symmetry as they expand.^{K} By the time the atom reaches the double-slit screen, the potential one-to-one correspondence between the photon's being emitted in a specific micromaser cavity and the atom's subsequent passage through a specific slit has been lost.

The system of the atom at the double-slit screen and the emitted photon in the expanded micromaser cavity is represented by the wave function:

Ψ(r)ₜₒₜₐₗ=[1/√2[ψ_{L}+ψ_{R}]][1/√2[|1_{L}0_{R}>+|0_{L}1_{R}>]]|b> [12]

where [1/√2[|1_{L}0_{R}>+|0_{L}1_{R}>]] represents the overlapping component wave functions for the single photon which before the opening of the shutter indicated the possibility of the photon being found specifically in either one or the other of the micromaser cavities. Orthogonality of the component wave functions representing the single photon is preserved after the opening of the shutter. The wave function for the system of the atom and photon also shows that the developing entanglement with regard to the atom's emitting a photon in a specific micromaser cavity and the atom's subsequent passage through a specific slit in the double-slit screen has been effectively lost with the overlap of the component wave functions representing the single photon. The overlap of these wave functions representing the single photon is represented by taking their sum.^{L} The distribution of atoms at the detection screen is found in P where:

P=|Ψₜₒₜₐₗ|²=¼[|ψ_{L}|²+|ψ_{R}|²+ψ_{L}*ψ_{R}+ψ_{R}*ψ_{L}][[<1_{L}0_{R}|+<0_{L}1_{R}|][|1_{L}0_{R}>+|0_{L}1_{R}>]]<b|b> [13]

The photon-cavity term equals 1 due to its normalization and:

P=|Ψₜₒₜₐₗ|²=¼[|ψ_{L}|+|ψ_{R}|²+ψ_{L}* ψ_{R}+ψ_{R}*ψ_{L}]<b|b> [14]

In terms of the symmetric and anti-symmetric transformation equations for the atomic states and the states of the radiation in the micromaser cavities noted earlier, the wave function for the system is:

Ψₜₒₜₐₗ=[ψ_{S}|1_{S},0_{A}>|b>] [15]

|ψ_{S}|1_{S},0_{A}> represents the state where the photon and the atom are represented only by their respective symmetric wave functions. The overall distribution of the atoms at the double-slit screen should exhibit complete interference like the distribution in FIG. 2 where there is no micromaser cavity system or laser. Opening the single shutter between the micromaser cavities after the atom leaves the micromaser cavity system and before the atom reaches the double-slit screen is a measurement of the location of the photon (i.e., that the photon is somewhere in the combined, single micromaser cavity).

Since the wave function components of the single photon for the left and right micromaser cavities maintain their symmetry as they expand once the single shutter is opened, it is useful to consider 1/√2[|1_{L}0_{R}>+|0_{L}1_{R}>] in terms of symmetric and anti-symmetric wave functions for the single photon:

|1_{L}0_{R}>=1/√2[|1_{S}0_{A}>+|0_{S}1_{A}>] [16]

|0_{L}1_{R}>=1/√2[|1_{S}0_{A}>−|0_{S}1_{A}>].^{M} [17]

Then:

1/√2[|1_{L}0_{R}>+|0_{L}1_{R}>]=1/√2[[1/√2[|1_{S}0_{A}>+|0_{S}1_{A}>]]+[1/√2[|1_{S}0_{A}>−|0_{S}1_{A}>]]]1/√2[|1_{L}0_{R}>+|0_{L}1_{R}>]=|1_{S}0_{A}>.^{N} [18]

It should be noted that eqns. 16 and 17 hold whether: 1) the shutter is closed and the component wave functions for the photon are confined to either one or the other of the micromaser cavities, or 2) the shutter is opened between the two micromaser cavities and the component wave functions for the photon expand into what is now a single micromaser cavity. That eqns. 16 and 17 hold in either condition 1 or condition 2 means that the component wave functions maintain their symmetry as they expand.

One can thus alter the overall distribution of physical entities from what it otherwise would be, in the present case the atoms passing through the Quantum Information Transmission Device (QITD), through an action that does not involve a direct physical interaction with those entities. The action in the proposed experiment is opening the shutter between the micromaser cavities after the atom exited the micromaser cavity system but before the atom reaches the double-slit screen. The action can affect the development of the overall atomic distribution at the detection screen (or other detection device). The capability to alter the overall distribution of atoms at the detection screen from what it would otherwise be through an action that does not involve a direct physical interaction with the atoms depends on the hidden character of the photon emitted by an atom passing through the micromaser cavity system.

One can in principle make the distance between the double-slit screen and the detection screen very large and delay the decision whether or not to open the single shutter separating the two micromaser cavities until just before the atom reaches the detection screen (FIGS. 7, 8). Repetition of the experimental procedure could be managed so as to create distinct atomic distributions at the detection screen, either the interference pattern like in FIG. 2 or the which-way pattern like in FIG. 3. These two patterns could be used to represent binary bits of information. In the procedure proposed here, it is possible to use the interference distribution pattern and the which-way distribution pattern to send binary information from the site of the micromaser cavities to near the site of the detection screen for the atoms and for this information to then be recorded in the atomic distributions at the detection screen.

The QITD is not a quantum eraser as discussed by Scully¹ and Kim⁴. Scully's quantum eraser is described essentially by eqns. 5 and 11 that are based on entanglement between the paired atoms and emitted photons in Scully's quantum eraser. These equations can also serve as a model for the entanglement of the paired signal and idler photons in Kim's quantum eraser. In Scully's quantum eraser, for example, this entanglement allows one to obtain sub-distribution patterns for the detected atoms correlated with either their erased or undetected emitted photons where these sub-distributions exhibit interference (most clearly seen in eqn. 11 and depicted in FIGS. 1 and 4) within an overall distribution characteristic of which-way information (the overall distribution like that found in FIGS. 1, 4 and 3 and described by eqn. 6). In contrast, in the QITD, an overall distribution characterized by Young-like interference (i.e., interference found in the classic double slit experiment where the double-slit is firmly anchored) occurs when the developing entanglement between paired atoms and emitted photons is interrupted (the overall distribution like that found in FIG. 2).

Ghirardi, Rimini, and Weber's argument on the “impossibility of superliminal transmission [of signals]“(p. 298) in quantum mechanics, as does Eberhard's on the same issue, assumes a single set of possible measurement results.^{9,10} For Ghirardi and colleagues, this single set of possible measurement results is represented by the statistical operator Q⁰. For Eberhard, this single set of possible measurement results is represented by a statistical distribution Q(λ) and two associated conditional probability functions involving possible measurement results at two separate physical locations. In the operation of the QITD, there are two possible sets of possible measurement results, regarding both the photon and the atom which are in the process of becoming entangled. One set concerns where the shutter separating the two micromaser cavities remains closed, and one set concerns where the shutter is opened before the atom reaches the double-slit screen. Thus, Ghirardi, Rimini, and Weber's argument, as well as Eberhard's, are not applicable to the scenario discussed here. The result that there are two possible sets of possible measurement results with the QITD depends on the hidden character of the photon emitted by the atom when the photon passes through the micromaser cavity system as well as the lack of any change in the motion of the atom as a result of this emission. The hidden character of the photon emitted by the atom when it passes through the micromaser cavity system is similar to the haunted measurement discussed by Greenberger and Yasin where a haunted measurement is undone while the existent measured is hidden. Greenberger and Yasin's haunted measurements were concerned with a single physical entity and not two spatially separated physical entities, such as the atom and emitted photon, whose wave functions are in the process of becoming entangled while the events concerning the photon are hidden.^{11,12}

Even though it is possible with the QITD to transfer information without the limitation of the velocity of light in vacuum, the QITD does not violate the limitation on the velocity of light in vacuum in the special theory of relativity as regards the transfer of anything physical.¹³ The atom passing through the QITD does not travel faster than the velocity of light.

As noted, the results discussed allow for the possibility of a transfer of information when a number of atoms are considered. Allow that a sufficient number of atoms (perhaps 100) are sent through this scenario to allow a distribution pattern to form when the atoms are detected. Consider that one has 100 pairs of micromaser cavities on a turntable, or carrel, and that each atom traverses a separate pair of micromaser cavities on the turntable. That is, after each run with an atom, the turntable rotates one position so that a new set of paired micromaser cavities is set in place for a new run.^{O}

If the shutter between the micromaser cavities for each pair is left closed after the pair of micromaser cavities is set in position for a run, a one-broad hump distribution pattern for the atoms characteristic of which-way information will develop (FIG. 9). If the shutter between these micromaser cavities is opened before the atom reaches the double-slit screen, a distribution based on a Young-like interference pattern for the atoms will develop (FIG. 10). Due to the developing entanglement of the atom's emitting a photon into one of the two micromaser cavities and the atom's subsequent passage through one of the slits in the double-slit screen, the atom can be a great distance from the micromaser cavity system and the photon contained therein before it reaches the double-slit screen and the wave function of the atom and the photon emitted by the atom can still change immediately upon the opening of the shutter between the micromaser cavities with the loss of the developing entanglement between the atom's emitting a photon into one of the two micromaser cavities and the atom's subsequent passage through one of the slits in the double-slit screen.

In this scenario with the shutter remaining closed, let the one-hump pattern formed from 100 atoms, for example, represent a binary “0.” In this scenario with the shutter opened in the manner noted, let the interference pattern formed from 100 atoms represent a binary “1.” One thereby has the basis for the transfer of information in the form of binary bits.

One just has to be able to distinguish the results for different runs of 100 atoms each at the site, or sites, where the atoms are detected to send multiple bits of information. Distinguishing between sets of results of 100 runs each can be achieved by sending each set of atoms in series over time using a single pair of micromaser cavities. Another example would be to use 1000 of the turntables noted above, operating simultaneously in a parallel setup and sending their respective photons along 1000 separate paths to 1000 detection screens electronically hooked together for summing pattern information from each screen (FIG. 11). In this way, one could send a brief message of 1000 bits to locations remote from the photons, each photon being released by the atom into one of a pair of micromaser cavities as each atom traversed the micromaser cavity system.

### NOTES FOR BACKGROUND OF THE INVENTION

^{A} Einstein essentially originated the idea of introducing latitude in the motion of the double-slit screen (i.e, not fixing the screen in one position). He suggested, though, that a single-slit screen that is placed in front of the anchored double slit screen has this latitude. As Bohr noted², the analysis of what occurs at the detection screen is independent of whether the single-slit screen or the following double-slit screen has this latitude in its motion.

^{B} Scully and his colleagues¹ wrote, “We have found a way, based on matter-wave interferometry, and recent advances in quantum optics, namely the micromaser and laser cooling, to obtain which-path or particle-like information without scattering or otherwise introducing large uncontrolled phase factors into the interfering beams. To be sure, we find that the interference fringes disappear once we have which-path information, but we conclude that this disappearance originates in correlations between the measuring apparatus and the systems being observed” (p. 111). They also wrote, “It is simply the correlations between the detectors (micromaser cavities) and the atomic beams which are responsible for the loss of coherence (interference fringes) in the present experimental arrangement” (p. 113).

^{C} For example, Scully and his colleagues¹ wrote, “The de Broglie wave length of the atom is, therefore, not affected when a cavity photon is emitted, and so we have an experiment which is ‘so delicate that it does not disturb’ the interference pattern” (p. 113). They also wrote, “We emphasize once more that the micromaser welcher Weg detectors are recoil-free; there is no significant change in the spatial wave function of the atoms” (p. 114).

^{D} Scully and his colleagues used Rydberg states of rubidium, specifically the transition from 63p_{3/2} to 61d_{5/2.} as the atom passed through the micromaser cavity system and spontaneously emitted a photon. The resonant micromaser cavities operated at about 21 GHz. These specifications were consistent with states used in various experiments. In particular, these states were used by Rempe, Walther, and Klein.^{14,15}

^{E} Regarding the significance of the double-slit screen, Scully and his colleagues wrote¹ regarding their experimental setup, “[Disregarding the laser and micromaser cavities,] a set of wider slits collimates two atom beams which illuminate the narrow slits where the interference pattern originates” (p. 112). The double-slit screen remains important as regards the atomic distribution at the detection screen with the introduction of the laser and micromaser cavities, as they also wrote, “[micromaser] cavities containing no photons initially store which-path information [with the atom's emitting the photon in one of the cavities in the micromaser cavity system] and therefore the interference pattern is lost. It [the distribution of the atoms at the detection screen] is changed to the incoherent superposition . . . of one-slit patterns” (p. 114) The atom's passage through the double-slit screen is responsible for the form of the distribution, namely superposed one-slit patterns, characteristic of which-way information.

^{F} The wave function is provisional due to the photon's being “hidden” in the micromaser cavity system and not knowing the specific cavity that the photon is in. Altering the experimental circumstances in a suitable manner may interrupt the development of the entanglement which becomes fully developed with the passage of the atom through the double-slit screen.

^{G} Scully and his colleagues relied on the “hidden” character of the photon in their prediction of the atomic distribution sub-interference patterns. If it was known into which specific micromaser cavity the atom emitted the photon, they would not have derived eqn. 5. The derivation of eqn. 5 relies on the possibility that the photon was emitted in either one or the other of the micromaser cavities.

^{H} This finding is supported by FIG. 5 in the paper by Kim and his colleagues and in his comments on that figure. Also, this finding was confirmed in an email communication with Kim.

^{I} There is a difference, though, in the two scenarios, although the difference turns out not to be of practical significance. For Scully, the photons in the micromaser cavities were “hidden;” information concerning into which specific micromaser cavity the photon was emitted by the atom traveling through the micromaser cavity system was not available because of the barrier that the micromaser cavities represented even though one knew that the atom passing through the micromaser cavity system emitted a photon into one of the two micromaser cavities. The existence of general which-way information concerning the emitted photon, though, was set (essentially, general which-way information was made available) with the “open” (i.e., not hidden) passage of the atom through the double slit screen since at that point the overall distribution of atoms at the detection screen was determined in part due to the existence of the photon in one of the micromaser cavities although the specific micromaser cavity was not known because the photon was hidden. In the Kim experiment, the specific which-way information was available, but it was not measured for those photons reflected by BS_M and BS_N before these photons reached the beam splitter BS at N where the which-way information was lost. In both the Scully and Kim experiments, general which-way information was available before which-way information was subsequently lost.

^{J} In the Quantum Information Transmission Device, Rydberg states of rubidium can be used, specifically the transition from 63p_{3,2} to 61d_{5/2.} as the atom passes through the micromaser cavity system and spontaneously emits a photon. The resonant micromaser cavities operate at about 21 GHz and do not contain any photons before the atom passes through the micromaser cavity system and emits a photon. Instead of rubidium other Rydberg states of atoms can be used in conjunction with suitably adjusted resonant micromaser cavities such that the excited atom is does not emit a photon until the atom enters the micromaser cavity system where it has a probability of one of spontaneously emitting a photon in one or the other of the micromaser cavities.

^{K} The significance of this symmetry being maintained will be discussed in more detail shortly.

^{L} Since the component wave functions for the single photon in the micromaser cavity system are for that single photon and the single photon is “hidden” in the micromaser cavity system, when the component wave functions overlap there is no way to distinguish between them. If the photodetector between the two micromaser cavities were installed prior to sending the atom into the micromaser cavity system (as Scully and his colleagues did), one could distinguish the two component wave functions after the shutters are opened and the photodetector is exposed. In the quantum information transmission device, there is no photodetector.

^{M} Except for the normalization constants, these wave functions can be obtained by adding and subtracting |1_{S},0_{A}>=1/√2 [|1_{L}0_{R}>+|0_{L}1_{R}>] and 51 0_{S},1_{A}>=1/√2 [|1_{L}0_{R}>−|0_{L}1_{R}>] defined by Scully and his colleagues.

^{N} After interrupting the development of the entanglement between the atom's emitting the photon in one of the micromaser cavities and the atom's subsequent passage through the fixed double-slit screen by opening the shutter before the atom reaches the double-slit screen, it may still be possible to establish which-way information and the associated one broad hump atomic distribution, like in FIG. 3. This could occur if the shutter is closed before the atom reaches the double-slit screen and the atom subsequently passes through the double-slit screen while the shutter remains closed. The system of the atom and the photon would then be characterized by eqn. 1 in “Background of the Invention.” The process of entanglement would be revived in this process.

^{O} A single run consists of an atom:
A. leaving the atom source toward the micromaser cavity system;
B. being excited by a laser into a state where it will spontaneously emit a photon in the micromaser cavity system;
C. entering the micromaser cavity system;
D. spontaneously emitting a photon in the micromaser cavity system;
E. exiting the micromaser cavity system;
F. passing through the double-slit screen;
G. being detected at a detection device.

### In addition, between steps E and F, it is possible that the single shutter separating the pair of micromaser cavities is opened.

^{P} Opening the shutter constitutes a measurement of the spatial location of the photon, in this case that the emitted photon is in the enlarged micromaser cavity formed from the two smaller micromaser cavities that had been separated by a single shutter.

### REFERENCES FOR BACKGROUND OF THE INVENTION

^{1.} M. O. Scully, B. G. Englert, and H. Walther, Quantum optical tests of complementarity. Nature (London), 351, 111-116, 1991.
^{2.} N. Bohr, Discussion with Einstein on epistemological problems in atomic physics. In P. A. Schilpp, Albert Einstein: Philosopher-scientist (vol. 1) (pp. 199-241). LaSalle Illinois: Open Court, 1949/1970.
^{3.} R. P. Feynman, R. B. Leighton, and M. Sands. The Feynman lectures on physics: Quantum Mechanics (vol. 3). Reading: Massachusetts: Addison-Wesley, 1965.
^{4.} Y. H. Kim, R. Yu, S. P. Kulik, Y. Shih, and M. O. Scully, Delayed-‘choice’ quantum eraser. Phys. Rev. Lett., 84, 1-5, 1999.
^{5.} S. P. Walborn, M. O. Terra Cunha, S. Padua, and C. H. Monken, Double-slit quantum eraser. Phys. Rev. A, 65, 033818-1-033818-6, 2002.
^{6.} D. N. Klyshko, Photons and nonlinear optics. New York: Gordon and Breach Science Publishers, 1988.
^{7.} Wikipedia. Spontaneous parametric down conversion. Nov. 11, 2006. http://en.wikipedia.org/wiki/Spontaneous Parametric Down Conversion.
^{8.} Patent application filed with United States Patent Office, Mar. 16, 2006, U.S. Ser. No. 11/348,061.
^{9.} Ghirardi, G. C., Rimini, A., and Weber, T. A general argument against superluminal transmission through the quantum mechanical measurement process. Lettere al Nuovo Cimeno, vol. 27, n. 10, 293-298, 8 Marzo 1980.
^{10.} Eberhard, P. H. Bell's theorem and the different concepts of locality. Il Nuovo Cimento, vol. 46 B, n. 2, 392-419, 11 Agosto 1978.
^{11.} Greenberger, D. and YaSin, A. The haunted measurement in quantum theory. In D. M. Greenberger, New Techniques and Ideas in Quantum Measurement Theory (pp. 449-457) as part of Annals of the New York Academy of Sciences (Vol 480). New York: New York Academy of Sciences, 1986.
^{12.} Greenberger, D. and YaSin, A. ‘Haunted’ measurements in quantum theory. Found. of Phys., 19, 679-704, 1989.
^{13.} Einstein, A. (1952). On the electrodynamics of moving bodies. In H. Lorentz, A. Einstein, H. Minkowski, and H. Weyl (Eds.), The principle of relativity, a collection of original memoirs on the special and general theories of relativity (pp. 35-65) (W. Perrett and G. B. Jeffrey, Trans.). New York: Dover. (Original work published 1905)
^{14.} S. Haroche, and D. Kleppner. Cavity quantum electrodynamics. Phys. Today, 42, 24-30 (January, 1989).
^{15.} G. Rempe, H. Walther, and N, Klein, Observation of quantum collapse and revival in a one-atom maser. Phys. Rev. Lett., 58, 353-356, 1987.

### BRIEF SUMMARY OF THE INVENTION

The Optical Quantum Information Transfer Device (OQITD) is an adaptation of the Quantum Information Transmission Device to a purely optical scenario with elements similar to those found in the quantum eraser experiment of Kim and his colleagues.^{1,2,3,4,A} The device contains an interferometer with two possible photon sources. The interferometer has full-silvered mirrors (M_Y and M_Z) positioned so that all photons reaching the mirrors initially originating from photon sources A or B that pass through M at the entrance to the interferometer are reflected toward N (FIG. 12). All photons initially originating at A or B are detected at detectors D1 or D2.

The photon moving through the interferometer (the idler photon) is initially entangled with a second paired photon (the signal photon) initially generated in the same process at a single location (i.e., one of two possible photon sources). The signal photon travels away from the interferometer and impacts a detection apparatus that detects the location of this photon along a spatial axis approximately perpendicular to the direction of travel of this photon.

The interferometer is placed in a shielding enclosure as depicted in FIG. 12 that prevents information concerning the state of the idler photons traveling through the interferometer from being available to the environment. This shielding enclosure is constructed so that it can open as well, as depicted in FIG. 13. Specifically, the shielding enclosure can be opened during the passage of the idler photon passing through the interferometer from M to N.

In the device, where the shielding device remains closed (FIG. 12), which-way information is potentially available until the idler photon traveling through the interferometer reaches BS. This which-path information derives from the two possible photon sources in the interferometer, each source associated uniquely with one path beginning at that source, passing through M and on to N. The potential which-path information is lost when the idler photon reaches BS at N (before the signal photon reaches its detection axis). One obtains interference like in FIG. 2 as if the developing entanglement between the specific source of both the paired idler and signal photons never existed.

With the shielding enclosure instead opened before the idler photon reaches BS (FIG. 13) and before the paired signal photon reaches its detection axis, which-path information is now publicly available and a specific observation can be made concerning the path of the idler photon before it reaches BS. In the event an observation of a specific path of the idler photon is not made before the photon reaches BS, even though the shielding enclosure has been opened, nonetheless which-way information still has been made available to the environment that the photon is traveling either one or the other of the paths between M and N. In other words, which-way information was available between M and N but only in a general sense. Information has been made available that the idler photon took either one or the other of the paths through the interferometer between M and N, but it is not known which specific path the idler photon took since a measurement of the specific path is not made. One obtains a distribution of signal photons paired to the idler photons like that in FIG. 3 indicating general which-path information concerning the idler photons.

If an observation of the specific path of the idler photon through the interferometer (between M and N) is not made by the time the idler photon reaches N, the opportunity to obtain this specific which-way information concerning the specific path of the photon from M to N is lost. That general which-way information had been publicly available is preserved in the form of the overall one broad hump distribution of the paired signal photons characteristic of which-way information. This analysis of the significance of publicly available general which-way information concerning the idler photons in obtaining an overall distribution of signal photons characteristic of general which-way information is supported by work on the quantum eraser.^{3,5}

In the OQITD, if the shielding enclosure remains closed until after the idler photon passes through, or is reflected off of, BS (t_{Idler}_{_{—}}_{BS}<t_{Signal}_{_{—}}ₓ, the paired signal photon reaches the signal photon detection axis after the idler photon interacts with BS), the general which-way information as regards the passage of the idler photon through the interferometer does not come into existence and the possibility of obtaining information concerning the specific path of the idler photon through the interferometer is lost. No information has been released to the environment that the idler photon took one or the other path through the interferometer before this information was lost with the idler photon's passage through BS. The developing one-to-one correspondence between a signal photon and an idler photon as regards their being created at a specific location is lost. Instead, one cannot determine at which of two possible locations a signal-idler photon pair was created. The distribution of idler photons at detectors D1 and D2 reflects the presence of complete interference like that found in a Mach-Zehnder interferometer (FIG. 14) in that all idler photons are detected at detector D1 and 0 photons are detected at detector D2.^{6,7} The distribution of the paired signal photons is like that found for the electrons in FIG. 2.

The signal photon distribution along a spatial axis reflects whether or not there is which-way information concerning the idler photons paired to the signal photons comprising the distribution. With the loss of information concerning the specific source of the idler photon comes a similar loss of information concerning the specific photon source of the paired signal photon. The signal photon itself loses the capacity to provide specific which-path (and thus which source) information through shielding the possible trajectories of the signal photon itself from its possible sources until at least the possible trajectories overlap (or perhaps even until the signal photon detection itself) (as depicted in FIGS. 12, 13). A lens can facilitate the far field effect and thus the overlap of the possible trajectories. Nonetheless, the signal photon remains entangled with the paired idler photon (except when the idler photon passes through or is reflected off, BS while the shielding enclosure remains closed) and thus reflects the status of the paired idler photon. A process like spontaneous parametric down conversion (SPDC) is used to create the signal-idler photon pairs. As exemplified in SPDC, the physical process of creation of these pairs does not itself provide which-way information concerning the path of the idler photon through the interferometer. With the loss of entanglement between the signal and idler photon when the idler photon passes through, or is reflected off, BS while the shielding enclosure remains closed (and t_{Idler}_{_{—}}_{BS}<t_{Signal}_{_{—}}ₓ), there is a loss of general which-path information concerning at which photon source the signal-idler photon pair originated.

In the OQITD, the signal photons can act as a measuring needle for the paired idler photons showing which-path information concerning paired idler photons in the overall signal photon distribution (like in FIGS. 3, 13) where the shielding device enclosing the interferometer is opened before these idler photons reach BS (and t_{Idler}_{_{—}}_{BS}<t_{Signal}_{_{—}}ₓ) or instead show evidence of interference concerning the paired idler photon in the overall signal photon distribution (like in FIGS. 2, 12) where the shielding enclosure remains closed until after the idler photon reaches BS (where t_{Idler}_{_{—}}_{BS}<t_{Signal}_{_{—}}ₓ,).

Leaving the shielding enclosure closed until after the idler photon reaches BS interrupts the developing entanglement concerning: 1) the idler photon's originating at a specific source and traveling a specific route through the interferometer correlated to this source, and 2) the paired signal photon's originating at the same specific source as the idler photon in the same process of creation and taking a specific path to the signal photon detection axis correlated to the specific source. Potential which-path information has been effectively lost due to the “hidden” character of the idler photon until after the idler photon passes through, or is reflected off, BS and to the making unavailable which-way information concerning the signal photon itself in the manner noted above.

For the OQITD, the wave function initially characterizing the paired signal photon and idler photon initially generated at one of two possible sources is:

Ψ=1/√2(ψ_{S}_{_{—}}_{A}ψ_{I}_{_{—}}_{A}+ψ_{S}_{_{—}}_{B}ψ_{I}_{B}) [1]^{B}

where ψ_{S}_{_{—}}_{A} and ψ_{S}_{_{—}}_{B} are the component wave functions for the signal photons originating at either source A or source B, respectively, and ψ_{I}_{_{—}}_{A} and ψ_{I}_{_{—}}_{B} are the component wave functions for the idler photons originating at either source A or source B, respectively.

P=|Ψₜₒₜₐₗ|²=½[|ψ_{S}_{_{—}}_{A}|²+|ψ_{S}_{B}|²+[(ψ_{S}_{_{—}}_{A}*ψ_{S}_{_{—}}_{B})(ψ_{I}_{_{—}}_{A}*ψ_{I}_{_{—}}_{B})]+[(ψ_{S}_{_{—}}_{B}*ψ_{S}_{_{—}}_{A})(ψ_{I}_{_{—}}_{B}*ψI_{_{—}}_{A})] [2]

### ψ_{I}_{_{—}}_{A} and ψ_{I}_{_{—}}_{B} are normalized so that |ψ_{I}_{_{—}}_{A}|²=1 and |ψ_{I}_{_{—}}_{B}|²=1. ψ_{I}_{_{—}}_{A} and ψ_{I}_{_{—}}_{B} are orthogonal and

(ψ_{I}_di —_{A}*ψ_{I}_{_{—}}_{B})=0 [3a]

(ψ_{I}_{_{—}}_{B}*ψ_{I}_{_{—}}_{A})=0. [3b]

P=|Ψₜₒₜₐₗ|²=½[|ψ_{S}_{_{—}}_{A}|²+|ψ_{S}_{_{—}}_{B}|²] [4]

Eqn. 1 applies before the photon reaches BS. It can apply after the photon reaches BS. It applies after the photon reaches BS and where the shielding enclosure has been opened before the idler photon reaches BS (like in FIG. 13). For these situations, there is a better formulation of eqn. 4 for this situation. Eqn. 1 can be written as:

Ψ=1/√2[[[1/√2(ψ_{S}_{_{—}}_{A}+ψ_{S}_{_{—}}_{B})][1/√2(ψ_{I}_{_{—}}_{A}+ψ_{I}_{_{—}}_{B})]]+[[1/√2[(ψ_{S}_{_{—}}_{A}−ψ_{S}_{_{—}}_{B})][1/√2(–_{I}_{_{—}}_{A}−ψ_{I}_{_{—}}_{B})]]] [5]

or

Ψ=1/√2[[(ψ+(_{S}_{_{—}}_{AB})ψ+(_{I}_{_{—}}_{AB})]+[ψ−(_{S}_{_{—}}_{AB})ψ−(_{I}_{_{—}}_{AB})]] [6]

with the ψ+ and ψ− used to represent symmetric and anti-symmetric functions that are defined in Table 1. Where the photon reaches BS and where the shielding enclosure has been opened before the idler photon reaches BS, 1/√2 (ψ_{I}_{_{—}}_{A}+ψ_{I}_{_{—}}_{B}) represents a situation where idler photons are detected at detector D1 and 1/√2 (ψ_{I}_{_{—}}_{A}−ψ_{I}_{_{—}}_{B}) represents a situation where idler photons are detected at detector D2.

TABLE 1
Symmetric and Anti-Symmetric Functions

| | | Associated | |
|---|---|---|---|
| | | with | Phase Change |
| | | Detection | Associated with |
| | | of Idler | Symmetric and |
| Definition of Symmetric and | | Photon at | Anti-Symmetric |
| Anti-Symmetric Functions | Eqn: | Detector: | Functions |
| ψ + (S_AB) = 1/√2 (ψS_A + | 7 | D1 | no phase change |
| ψS_B) | | | |
| ψ − (s_AB) = 1/√2 (ψS_A − | 8 | D2 | ½ λ phase change |
| ψS_B) | | | |
| ψ + (I_AB) = 1/√2 (ψI_A + | 9 | D1 | no phase change |
| ψI_B) | | | |
| ψ − (I_AB) = 1/√2 (ψI_A − | 10 | D2 | ½ λ phase change. |
| ψI_B) | | | |

When the interferometer is placed in a shielding enclosure as depicted in FIG. 12, and the idler photon travels within this shielding enclosure from its creation until after it passes through, or is reflected off of, BS, after the idler photon passes through or is reflected off BS at N, the system of the signal and idler photons becomes represented by the wave function:

Ψₜₒₜₐₗ=[1/√2[ψ_{S}_{_{—}}_{A}+ψ_{S}_{_{—}}_{B}]][1/√2[ψ_{I}_{_{—}}_{A}+ψ_{I}_{_{—}}_{B]]} [11]

where 1/√2[ψ_{I}_{_{—}}_{A}+ψ_{I}_{_{—}}_{B}] represents the overlapping component wave functions for the single idler photon which before reaching BS indicated the possibility of the idler photon being detected at either detector D1 or detector D2 (i.e., ψ_{I}_{_{—}}_{A} and ψ_{I}_{_{—}}_{B} are localized and do not overlap before the idler photon reaches BS). ψ_{I}_{_{—}}_{A} and ψ_{I}_{_{—}}_{B} originally indicated the possibility of the photon being detected in either one or the other of the detectors respectively (detector D1 for ψ_{I}_{_{—}}_{A} and detector D2 for ψ_{I}_{_{—}}_{B}). After the idler photon passes through or is reflected off BS at N, while the shielding enclosure remains closed, ψ_{I}_{_{—}}_{A} now indicates that the idler photon can be detected at D1 or D2 and similarly ψ_{I}_{_{—}}_{B} now indicates that the idler photon can be detected at D1 or D2.

Orthogonality of the component wave functions representing the single idler photon is preserved after the idler photon reaches BS. The wave function for the system of the signal and idler photons shows that the developing entanglement with regard to: 1) the idler photon's creation at a specific source and traveling a specific route through the interferometer correlated to this source and 2) the paired signal photon's creation in the same process as the idler photon at the same specific source as the idler photon and taking a specific path to the signal photon detection axis correlated to the specific source, has been effectively lost with the overlap of the component wave functions representing the single idler photon (i.e., ψ_{I}_{_{—}}_{A}+ψ_{I}_{_{—}}_{B}). The overlap of these component wave functions representing the single idler photon is represented by taking their sum. The distribution of signal photons at the detection axis is found in P where:

P=|Ψₜₒₜₐₗ|²=¼[|ψ_{S}_{_{—}}_{A}|²+|ψ_{S}_{_{—}}_{B}|²+ψ_{S}_{_{—}}_{A}*ψ_{S}_{_{—}}_{B}+ψ_{S}_{_{—}}_{B}*ψ_{S}_{_{—}}_{A}][[ψ_{I}_{_{—}}_{A}*+ψ_{I}_{_{—}}_{B}*][ψ_{I}_{_{—}}_{A}+ψ_{I}_{_{—}}_{B}]]. [12]

¼[ψ_{I}_{_{—}}_{A}*+ψ_{I}_{_{—}}_{B}*][ψ_{I}_{_{—}}_{A}+ψ_ I_{_{—}}_{B}]=1 [13]

due to normalization of

[1/√2[ψ_{I}_{_{—}}_{A}+ψ_{I}_{_{—}}_{B}]

and:

P=|Ψₜₒₜₐₗ|²=¼[|ψ_{S}_{_{—}}_{A}|²+|ψ_{S}_{_{—}}_{B}|²+ψ_{S}_{_{—}}_{A}*ψ_{S}_{_{—}}_{B}+ψ_{S}_{_{—}}_{B}* ψ_{S}_{_{—}}_{A}] [14]

In terms of the symmetric and anti-symmetric transformation equations for the signal photons and the idler photons, the wave function for the system, eqn. 11 can be expressed as:

Ψ=ψ+(_{S}_{_{—}}_{AB})ψ+(_{I}_{_{—}}_{AB}) [15]

ψ+(_{S}_{_{—}}_{AB})ψ+(_{I}_{_{—}}_{AB}) represents the state where the signal photon and the idler photon are represented only by their respective symmetric wave functions. The distribution of the signal photons along the spatial axis where they are detected should exhibit complete interference like the distribution in FIG. 2. Keeping the shielding enclosure closed until after the idler photon passes through BS is a measurement of the path of the idler photon between M and N, specifically that it is not known which-path the idler photon took through the interferometer.

Since the wave function components of the idler photon for the photon being detected at detector DI or detector D2 maintain their symmetry when the idler photon passes through or is reflected at BS, it might be useful to explicitly consider 1/√2[ψI_{_{—}}_{A}+ψ_{I}_{_{—}}_{B}] in terms of symmetric and anti-symmetric wave functions for the single idler photon:

ψ_{I}_{_{—}}_{A}=1/√2[ψ+(_{I}_{_{—}}_{AB})+ψ−(_{_{—}}_{AB})] [16]

ψ_{I}_{_{—}}_{B}=1/√2[ψ+(_{I}_{_{—}}_{AB})−ψ−(_{I}_{_{—}}_{AB})]. [17]

Then:

1/√2[ψ_{I}_{_{—}}_{A}+ψ_{I}_{_{—}}_{B}]=1/√2[[1/√2[ψ+(_{I}_{_{—}}_{AB})+ψ−(_{I}_{_{—}}_{AB})]]+[1/√2[ψ+(_{I}_{_{—}}_{AB})−ψ−(_{I}_{_{—}}_{AB})]]]1/√2[ψ_{I}_{_{—}}_{A}+ψ_{I}_{_{—}}_{B}]=ψ+(_{I}_{_{—}}_{AB}). [18]

It should be noted that eqns. 16 and 17 hold: 1) before the idler photon passes through, or is reflected, at BS, and 2) after the idler photon passes through, or is reflected, at BS. That eqns. 16 and 17 hold in either condition 1 or condition 2 means that the component wave functions maintain their symmetry in both these conditions.

One can thus alter a distribution of physical entities from what the distribution otherwise would have been, in the present case the signal photons of the OQITD, through an action that does not involve a direct physical interaction with those signal photons. The action in the proposed experiment is the idler photon's passing through, or being reflected off, BS before the shielding enclosure for the interferometer is opened. The passage of the idler photon through BS, or its being reflected off BS, can affect the development of the overall distribution of the paired signal photons at the detection axis. The capability to alter the overall distribution of the paired signal photons at the detection axis through an action that does not involve a direct physical interaction with these signal photons depends on the hidden character of the idler photons as they pass through from M to N where BS is located.

If the shielding enclosure remains closed, the distribution of idler photons at detectors D1 and D2 reflects the presence of complete interference like that found in a Mach-Zehnder interferometer (FIG. 14), where there is a single photon source, in that all idler photons are detected at detector D1 and 0 photons are detected at detector D2.

In the OQITD, if the shielding enclosure is left closed until after the idler photon passes through, or its reflected at, BS at N, then after the idler photon is reflected from, or passes through, BS, Ψₜₒₜₐₗ_{_{—}}_{I} from M until the photon reaches N is (from eqn. 11):

Ψₜₒₜₐₗ_{_{—}}_{I}=1/√2[ψ_{I}_{_{—}}_{A}+ψ_{I}_{_{—}}_{B}]

Taking the interaction of the photon with BS into account, the wave equation for the idler photon is the following:

Ψₜₒₜₐₗ_{_{—}}_{I}=[1/√2][1/√2(ψ_{N,detector}_{_{—}}_{D1}+ψ_{N,detector}_{_{—}}_{D2})]+[1/√2][1/√2(ψ_{N,detector}_{_{—}}_{D1}−ψ_{N,detector}_{_{—}}_{D2})]] [19]

where 1/√2 (ψ_{N,detector}_{_{—}}_{D1}+ψ_{N,detector}_{_{—}}_{D2}) represents the component wave function for the idler photon that travels path A before reaching BS and 1/√2 (ψ_{N,detector}_{_{—}}_{D1}−ψ_{N,detector}_{_{—}}_{D2}) represents the component wave function for the idler photon that travels path B before reaching BS. ψ_{N,detector}_{_{—}}ₓ represents the wave function component for the idler photon traveling from N to detector x. −ψ_{N,detector}_{_{—}}_{D2} occurs since there is a total phase change of ½λ for the component wave function of the photon that travels the lower arm of the interferometer associated with the idler photon's originating at B (ψ_{I}_{_{—}}_{B}) and is reflected at BS to detector 2.

Ψₜₒₜₐₗ_{_{—}}_{I}=ψ_{N,detector}_{_{—}}_{D1} [20]

The equation for the photon traveling through the Mach-Zehnder interferometer before the photon reaches the second beam splitter BS in front of the detectors D1 and D2 is:

ψₚₕₒₜₒₙ=1/√2[ψ_{U}+ψ_{L}] [21]

where ψ_{U} and ψ_{L} are respectively the wave function components for the photon along the upper arm and the lower arm of the interferometer that the photon initially travels over after passing through, or being reflected off of, the initial beam splitter.

Taking the second beam splitter into account, the wave equation for the system is the following:

ψ=[[1/√2][1/√2(ψ_{N,detector}_{_{—}}_{D1}+ψ_{N,detector}_{_{—}}_{D2})]]+[[1/√2][1/√2(ψ_{N,detector}_{_{—}}_{D1}−ψ_{N,detector}_{_{—}}_{D2})]] [22]

where 1/√2 (ψ_{N,detector}_{_{—}}_{D1}+ψ_{N,detector}_{_{—}}_{D2}) represents the component wave function for the idler photon that travels path U before reaching BS and 1/√2 (ψ_{N,detector}_{_{—}}_{D1}−ψ_{N,detector}_{_{—}}_{D2}) represents the component wave function for the idler photon that travels path L before reaching BS. −ψ_{N,detector}_{_{—}}_{D2} occurs since there is a total phase change of ½λ for the component wave function of the photon that travels the lower arm of the interferometer (ψ_{L}) and that is reflected at BS to detector D2.

ψ=ψ_{N,detector}_{_{—}}_{D1} [23]

This result is the same result obtained in eqn. 20 for the OQITD where the shielding enclosure is left closed until after the idler photon passes through, or is reflected at, BS at N.

One can in principle make the distance between the signal-idler photon source/s and the detection axis for the signal photon very large and delay the decision whether or not to open the shielding enclosure on the interferometer until just before the signal photon reaches the detection screen. Also, in this case, the shielded interferometer must be “extended” so that the idler photon passes through or is reflected from BS just before its paired signal photon reaches the spatial axis along which the signal photon detector is located.

Repetition of the experimental procedure could be managed so as to create distinct signal photon distributions at the signal photon detection screen, either the interference pattern like in FIG. 12 (also shown in FIG. 2) or the which-way pattern like in FIG. 13 (also shown in FIG. 3). These two patterns could be used to represent binary bits of information. In the procedure proposed here, it is possible to use the interference distribution pattern or the which-way distribution pattern to send binary information from the site of the interferometer mechanism to near the site of the signal photon detection screen for the signal photons and for this information to be expressed through distributions of signal photons at the detection screen in different sets of runs of the OQITD.

In the OQITD, the concern is with the presence or absence of interference characteristic of overall idler photon distributions and by extension the overall paired signal photon distributions. In the OQITD, one need not correlate paired signal-idler photon detections in order to decipher signal photon sub-distributions within the overall distribution of signal photons.

In contrast, in the experiment by Scully and his colleagues, it was not possible to use the sub-interference patterns they obtained to send information from the site of the micromaser cavities to near the site of the detection screen for the atoms by locating the double-slit screen near the site of the detection screen. In the experiment by Scully and his colleagues, the entangled entities were: 1) the atom passing through the micromaser cavity system, through the double-slit screen, and traveling on to the detection device, and 2) the photon deposited by the atom in the micromaser cavity system and possibly detected by the photodetector when the shutters separating the micromaser cavities were opened.

In the experiment by Scully and his colleagues, the correlations between these entangled entities cannot be developed until after the atoms are detected at the detection screen and the shutters separating the micromaser cavities opened. The correlations are necessary because of the overlap of the sub-distributions for the atoms at the single detection screen where the overlap of these sub-distributions for the atoms form the one wide curve characteristic of which-way information. The only way to determine whether an atom impacting the detection screen is a member of the symmetric (fringes) or anti-symmetric (anti-fringes) sub-distribution is through the noted correlation.

The same point would hold in the experiment by Kim and his colleagues where the concern is with the distributions of the signal photons along a spatial axis (i.e., the signal photon detection axis). It is necessary to correlate results concerning the entangled paired signal and idler photons for those photon pairs where the idler photon is reflected toward BS at N from Y or Z to discriminate the fringe and anti-fringe distributions of the paired signal photons (characteristic of interference) in the overall one wide hump for these signal photons (characteristic of which-way information). In the Kim experiment, there is also the fundamental complicating factor of using half-silvered mirrors at Y and Z which results in not knowing for sure that idler photons will be reflected at Y or Z. ½ of the idler photons of the generated signal-idler photon pairs, pass through the ½ silvered mirrors at Y and Z instead of being reflected like the other ½ of the signal photons reaching Y or Z. Whether or not the idler photon passes through or is instead reflected at Y or Z (where there is a ½ silvered mirror) is a random process.

In contrast, in the OQITD, this overlap of the fringe and anti-fringe sub-distributions is not relevant because the concern is not with sub-distributions showing interference within an overall distribution characteristic of the presence of which-way information. In the OQITD, the concern is with the presence or absence of interference characteristic of overall idler photon distributions and by extension the overall paired signal photon distributions. As noted, in the OQITD, one need not correlate paired signal-idler photon detections in order to decipher signal photon sub-distributions within the overall distribution of signal photons.

When the shielding enclosure over the interferometer is opened in a set of runs before the idler photon reaches BS at N (and the paired signal photon reaches the signal photon detection axis after the idler photon reflects off, or passes through, BS) ½ of the idler photons are detected at detector D1 and ½ of the idler photons detected at detector D2. One of the detectors (i.e., detector D1) is associated with the symmetric wave function for the idler photon interacting with the beam splitter BS at N and the other detector (detector D2) is associated with the anti-symmetric wave function for the same idler photon interacting with BS (as noted in Table 1). When the idler photon detection is made, the idler photon is in either the symmetric or anti-symmetric state (i.e., detected at either at detector D1 or at detector D2, respectively). The overall distribution of the paired signal photons at the signal photon detection axis is the one wide hump characteristic of which-path information (like in FIG. 13 or FIG. 3).

On the other hand, when the shielding enclosure over the interferometer remains closed in a set of runs until after the idler photon reaches BS (and the paired signal photon reaches the signal photon detection axis after the idler photon reflects off, or passes through, BS, t_{Idler}_{_{—}}_{BS}<t_{Signal}_{_{—}}ₓ), all of the idler photons are detected at detector D1 and 0 idler photons are detected at detector D2. The paired signal photons show complete Young-like interference as depicted in FIG. 12 or FIG. 2. Table 2 displays the two different scenarios and the expected distribution of paired signal photons at the signal photon detection axis.

TABLE 2
Signal Photon Distribution at the Signal Photon
Detection Axis in a Set of Runs in Either Open or Closed Scenario

| | | Expected Overall |
|---|---|---|
| | | Distribution of |
| Scenario | Description: | Signal Photons: |
| Open | The shielding enclosure over the | Overall distribution |
| | interferometer is opened in a set of runs | characteristic of |
| | before the idler photon reaches BS at N | which-path |
| | (and the paired signal photon reaches | information (like in |
| | the signal photon detection axis after | FIG. 3 or 13): one |
| | the idler photon reflects off, or passes | wide hump. |
| | through, BS). | |
| Closed | The shielding enclosure over the | Overall distribution |
| | interferometer remains closed in a set | characteristic of |
| | of runs until after the idler photon | Young-like |
| | reaches BS (and the paired signal | interference (like in |
| | photon reaches the signal photon | FIGS. 2 or 12): |
| | detection axis after the idler photon | many narrow |
| | reflects off, or passes through, BS). | hillocks. |

The results discussed allow for the possibility of a transfer of information when a number of signal-idler photon pairs are considered. Allow that a sufficient number of signal-idler photon pairs (perhaps 100 in a set of runs) are sent through this scenario to allow a distribution pattern to form when the signal photons are detected. The idler photon passes through or be reflected at BS at N before the signal photon reaches the signal photon detection axis.

In the closed scenario, a pattern detector for the distribution of signal photons along their detection axis over a set of runs can determine the bit sent, in this case a “1”. In the open scenario, a pattern detector for the distribution of signal photons along their detection axis over a set of runs can determine the bit sent, in this case a “0”. A bit assembler can collect the bits generated by the pattern detector over a number of sets of runs of the OQITD and assemble them in sequential order. Table 3 displays the type of scenario for a set of runs (i.e., closed or open), the expected distribution of signal photons, and the assigned bit value. Through assigning a unique bit value to each of the distinct distributions of signal photons, a basis is established for the transfer of information in the form of binary bits from the vicinity of BS to the signal photon detection axis. (In the open scenario, the transfer is more specifically from the location where the shielding enclosure over the interferometer opens.)

TABLE 3
Type of Scenario, Expected Distribution of Signal Photons, and
Assigned Bit Value for a Set of Runs Sufficient to Distinguish the Two
Possible Distributions

| | Expected Distribution of Signal | |
|---|---|---|
| Scenario | Photons | Assigned Bit Value |
| Open | Overall distribution characteristic of | “0” |
| | which-path information (like in FIG. 3 | |
| | or 13): one wide hump. | |
| Closed | Overall distribution characteristic of | “1” |
| | Young-like interference (like in FIGS. 2 | |
| | or 12): many narrow hillocks. | |

Detecting the idler photons at detectors D1 and D2 and using a separate idler photon bit detector and a separate idler photon bit assembler for these idler photons in the signal-idler photon pairs acts as a check on the accuracy of the message being sent to the signal photon detection axis. Table 4 displays the type of scenario for a set of runs (i.e., closed or open), the expected distribution of signal photons, and the expected distribution of idler photons corresponding to the expected distribution of signal photons.

TABLE 4
Type of Scenario, Expected Distribution of Signal Photons, and
Expected Distribution of Idler Photons Corresponding to the Expected
Distribution of Signal Photons

| | Expected Distribution of Signal | Expected Distribution of |
|---|---|---|
| Scenario | Photons | Idler Photons |
| Open | Overall distribution characteristic | ½ of idler photons |
| | of which-path information (like in | entering interferometer |
| | FIG. 3 or 13): one wide hump. | detected at D1; |
| | | ½ of idler photons |
| | | entering interferometer |
| | | detected at D2. |
| Closed | Overall distribution characteristic | All of idler photons |
| | of Young-like interference (like in | entering interferometer |
| | FIGS. 2 or 12): many narrow | detected at D1. |
| | hillocks. | |

One can conduct runs sequentially with a single OQITD to generate sequentially the binary bits of a message. One could also set up a series of OQITD devices in parallel and run them simultaneously to generate a multi-bit message simultaneously.

The OQITD can operate where the signal photon detection axis is distant from the location where the signal-idler photon pairs are generated, allowing for the transfer of information over a long distance. The information transfer can occur, in part, faster than the speed of light in vacuum. It should be emphasized that there is no physical transfer that occurs faster than the speed of light in vacuum with the OQITD.

Spontaneous parametric down conversion (SPDC) can be used to create the signal-idler photon pairs where a pump laser beam is split with a double slit. The two resulting beams interact with a non-linear optical crystal. These two possible interaction areas in the non-linear optical crystal are the two possible sources of the signal-idler photon pair.^{1,8,9} The energy and momentum of the created signal and idler photon equals the energy and momentum of the original photon from which the signal and idler photons are created. The non-linear crystal is left unchanged in the process of the creation of the signal idler photon pair.^{8,9} The fact that the crystal is not changed in the process of creating the signal-idler photon pair from the incoming photon to the crystal is important to the operation of the OQITD.

As noted earlier, Ghirardi, Rimini, and Weber's argument on the “impossibility of superliminal [signal] transmission” (p. 298) in quantum mechanics, as does Eberhard's on the same issue, assumes a single set of possible measurement results.^{10,11} It was also noted that as regards the Quantum Information Transmission Device (QITD), there are two possible sets of possible measurement results, regarding both the photon and the atom which are in the process of becoming entangled.

In the Optical Quantum Information Transfer Device (OQITD), there are also two possible sets of possible measurement results, regarding both the signal and idler photons which are in the process of becoming entangled. One set concerns where the shielding enclosure around the interferometer remains closed until after the idler photon passes through, or reflects off, the beam splitter BS at N (and the paired signal photon reaches the signal photon detection axis after the idler photon reflects off, or passes through, BS). The other set concerns where the shielding enclosure over the interferometer is opened in a set of runs before the idler photon reaches BS at N (and the paired signal photon reaches the signal photon detection axis after the idler photon reflects off, or passes through, BS, t_{Idler}_{_{—}}BS<t_{Signal}_{_{—}}ₓ).

Thus, Ghirardi, Rimini, and Weber's argument, as well as Eberhard's, are not applicable to the OQITD. Even though information transfer with the OQITD is not subject to the limitation of the velocity of light in vacuum, the device does not violate the limitation on the velocity of light in vacuum in the special theory of relativity.¹² This result depends on the hidden character of certain events in the OQITD, specifically 1) the idler photon's originating at a specific source and traveling a specific route through the interferometer correlated to this source, 2) the paired signal photon's originating at the same specific source as the idler photon in the same process of creation and taking a specific path to the signal photon detection axis correlated to the specific source, and 3) the idler photon's interaction with BS (either passing through or being reflected off of BS).

### NOTES FOR BRIEF SUMMARY OF THE INVENTION

^{A} The experimental arrangement used by Kim and his colleagues is altered in at least the following ways: 1) the beam splitters BS_Y and BS_Z (which are half-silvered mirrors) located at Y and Z are replaced by full-silvered mirrors (M_Y and M_Z) positioned so that all photons reaching the mirrors initially originating from photon sources A or B that pass through M and are reflected toward N (FIG. 12) (so that all photons initially originating at A or B are detected at detectors D1 or D2); 2) the interferometer is placed in a shielding enclosure as depicted in FIG. 12 that prevents information concerning the state of the idler photons traveling through the interferometer from being available to the environment (and this shielding enclosure is constructed so that it can open as well, as depicted in FIG. 13; specifically, the shielding enclosure can be opened during the passage of the idler photon passing through the interferometer from M to N); 3) the signal photons are shielded at least from their origin/s until their possible trajectories overlap (and perhaps all the way to the signal photon detection axis); the signal photon does not reach the signal photon detection axis until after the it paired idler photon interacts with BS.

^{B} Eqns. 1, 5-10 were developed by a colleague.

### REFERENCES FOR BRIEF SUMMARY OF THE INVENTION

¹ D. M. Snyder, A variation of the classic double-slit experiment in quantum mechanics. March, 2006 Meeting of the American Physical Society.
² D. M. Snyder, Is it possible to use a quantum eraser to send binary data to a remote location? CERN Document Server: rev. version of SIS-2005-005. March, 2007. http://cdsweb.cern.ch/record/1019984.
³ Y. H. Kim, R. Yu, S. P. Kulik, Y. Shih, and M. O. Scully, Delayed-‘choice’ quantum eraser. Phys. Rev. Lett., 84, 1-5, 1999.
⁴ D. M. Snyder, An optical quantum information transfer device. March, 2007 Meeting of the American Physical Society.
⁵ M. O. Scully, B. G. Englert, and H. Walther, Quantum optical tests of complementarity. Nature (London), 351, 111-116, 1991.
⁶ D. M. Harrison. Mach-Zehnder interferometer. http://www.upscale. utoronto.ca/GeneralInterest/Harrison/MachZehnd.
⁷ Wikipedia. Mach-Zehnder interferometer. Aug. 29, 2006. http://en.wikipedia.org/wiki/Mach-Zehnder_Interferometer.
⁸ D. N. Klyshko, Photons and nonlinear optics. New York: Gordon and Breach Science Publishers, 1988.
⁹ Wikipedia. Spontaneous parametric down conversion. Nov. 11, 2006. http://en.wikipedia.org/wiki/Spontaneous Parametric Down Conversion.
¹⁰ Ghirardi, G. C., Rimini, A., Weber, T. A general argument against superluminal transmission through the quantum mechanical measurement process. Lettere al Nuovo Cimeno, vol. 27, n. 10, 293-298, 8 Marzo 1980.
¹¹ Eberhard, P. H. Bell's theorem and the different concepts of locality. Il Nuovo Cimento, vol. 46 B, n. 2, 392-419, 11 Agosto 1978.
¹² Einstein, A. (1952). On the electrodynamics of moving bodies. In H. Lorentz, A. Einstein, H. Minkowski, and H. Weyl (Eds.), The principle of relativity, a collection of original memoirs on the special and general theories of relativity (pp. 35-65) (W. Perrett and G. B. Jeffrey, Trans.). New York: Dover. (Original work published 1905)

### BRIEF DESCRIPTION OF THE SEVERAL VIEWS OF THE DRAWING

FIG. 1—Overview of basic features of quantum eraser experiment described Scully and colleagues. There are two shutters, one shutter between one micromaser cavity and the photodetector and one shutter between the other micromaser cavity and the photodetector. Two sub-interference patterns are shown that sum to the one-hump distribution characteristic of which-way information concerning the path of the atoms to the detection screen. The sub-interference patterns depend on correlating: 1) whether the photon that had been located in one of the two micromaser cavities was or was not detected by the photodetector when the shutters were opened and 2) the detection of the atom that had emitted the photon in the micromaser cavity system at the detection screen.

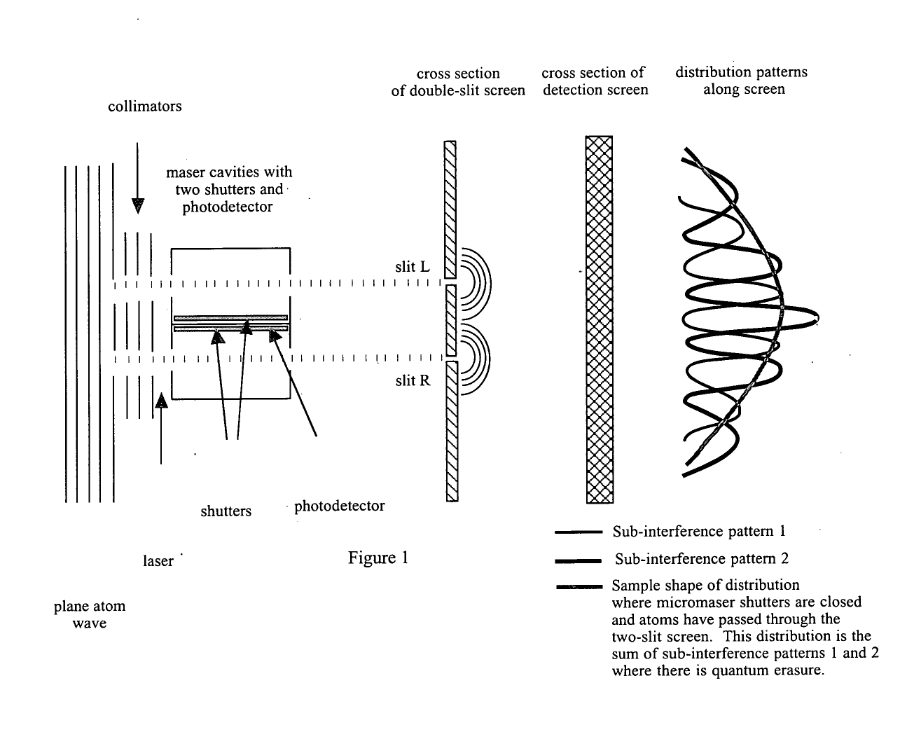

FIG. 2—Overview of thought experiment (i.e., gedankenexperiment) in which the distribution of electrons passing through an anchored double-slit screen indicates interference in the wave functions of the electrons. The interference pattern depends on the electron passing through both slits in the double-slit screen.

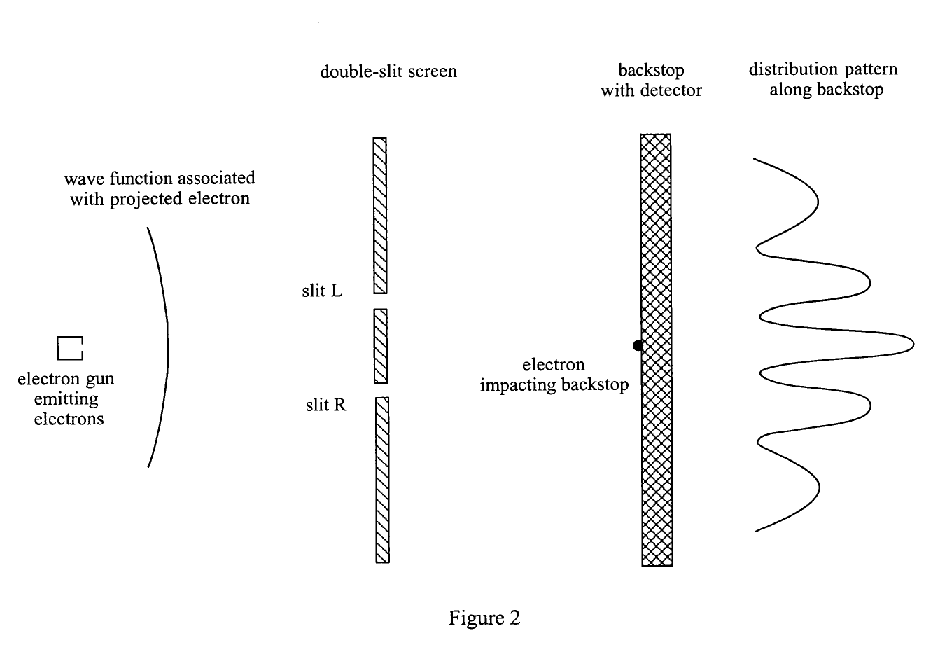

FIG. 3—Overview of thought experiment (i.e., gedankenexperiment) in which the distribution of electrons passing through a double-slit screen on rollers is used to determine through which slit in the double-slit screen the electron passed on its way to the detection screen. The distribution of electrons at the detection screen indicates that each electron passed through either one or the other slit in the double-slit screen on its path to the detector device.

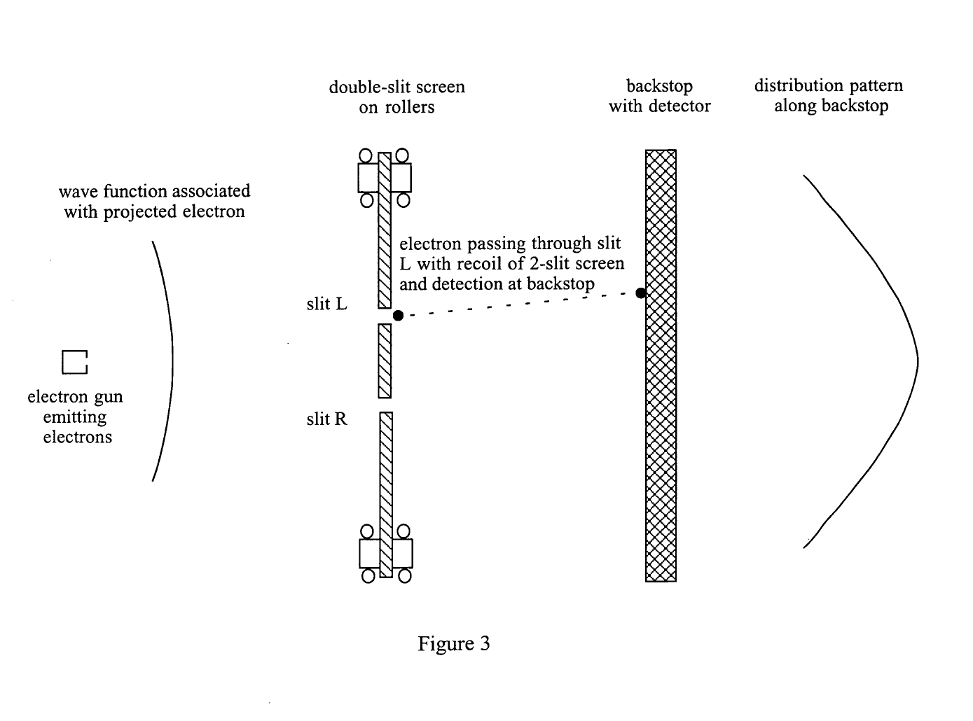

FIG. 4—Schematic of the experiment by Kim and his colleagues involving entangled pairs of signal and idler photons with the idler photon traveling through an interferometer that also allows a photon to exit the interferometer along either arm of the interferometer before the beam splitter where the component wave functions for the idler photon combine.

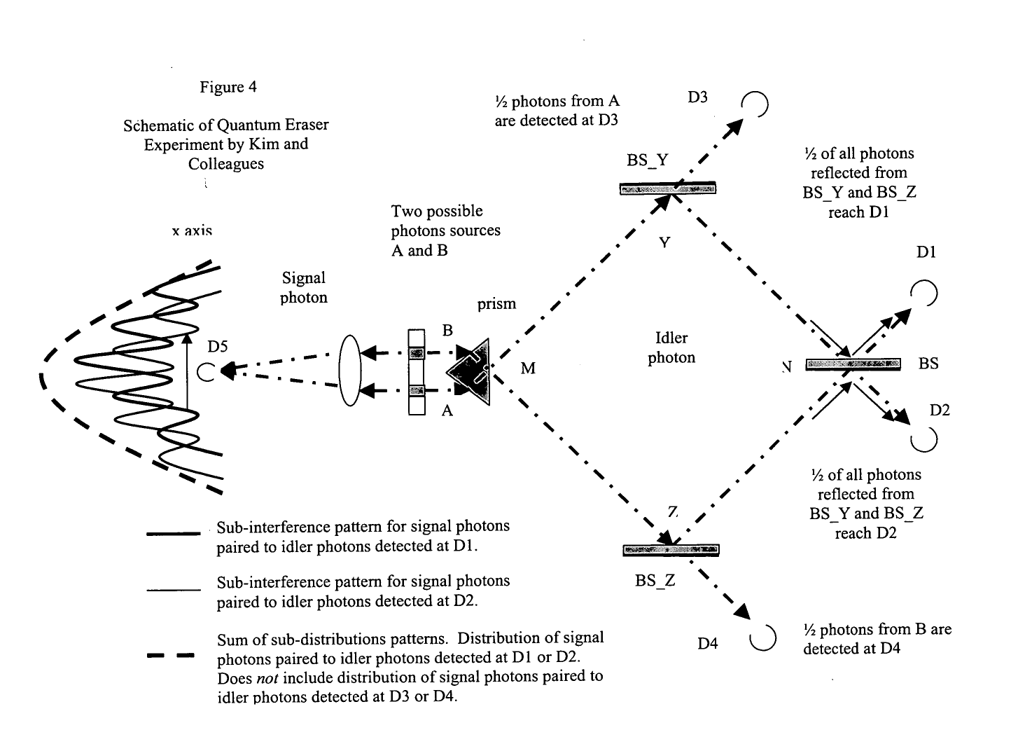

FIG. 5—Overview of basic features of the Quantum Information Transmission Device (QITD) with the single shutter between the micromaser cavities remaining in closed position. There is no photodetector. The distribution of the atoms at the detection screen is the one broad hump characteristic of which-way information concerning the path of the atoms to the detection screen. The atom passed through only one slit in the double-slit screen, although it is not known through which specific slit the atom passed.

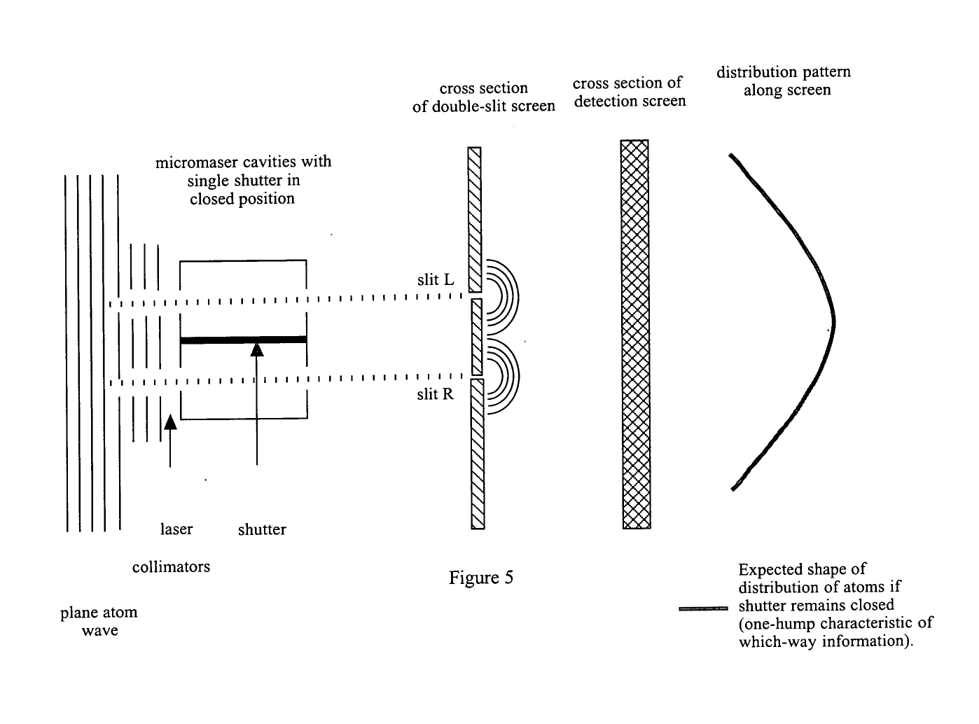

FIG. 6—Overview of basic features of the Quantum Information Transmission Device with the single shutter opened after the atom exists micromaser cavity where it emitted a photon and before the atom reaches the double-slit screen. There is no photodetector. The distribution of the atoms at the detection screen is the distribution pattern characteristic of interference (the lack of which-way information concerning the path of the atoms to the detection screen).

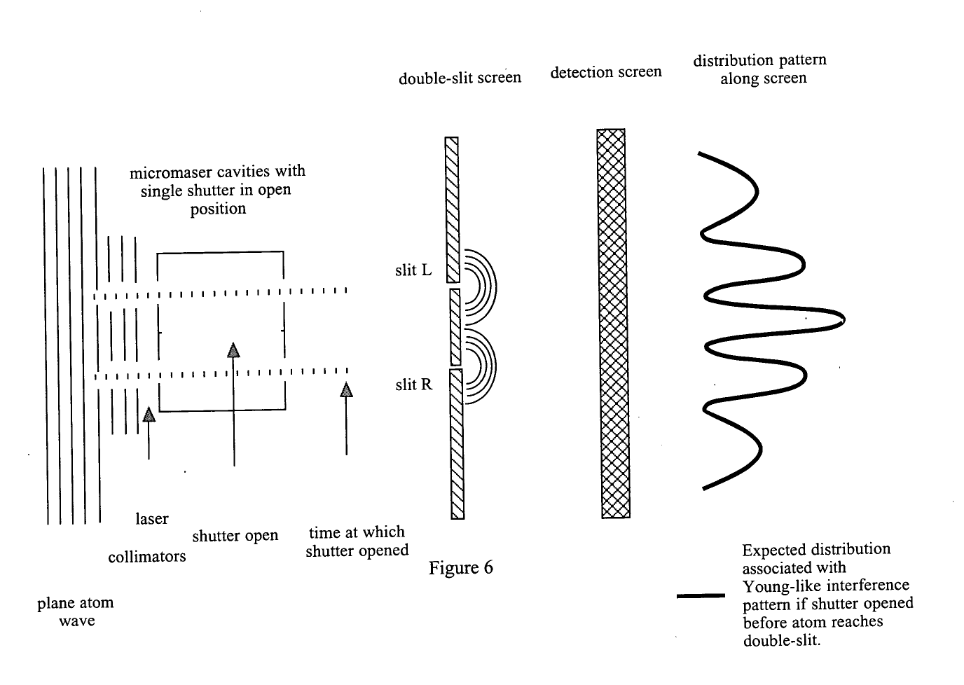

FIG. 7—Overview of basic features of the Quantum Information Transmission Device where the double-slit screen is placed near the detection screen, the single shutter between the micromaser cavities remains in closed position, and which-way information is depicted. If repeated many times, the atomic distribution at the detection screen is the one broad hump characteristic of which-way information. One can decide whether to obtain “which-way” information or not to obtain such information (and show interference) until the atom passes through the double-slit screen.

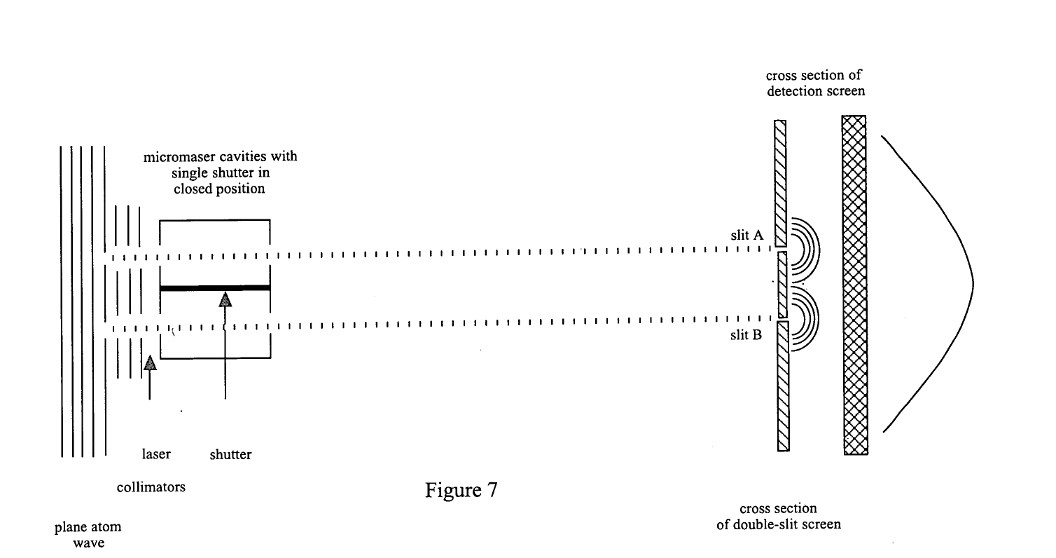

FIG. 8—Overview of basic features of the Quantum Information Transmission Device where the double-slit screen is placed near the detection screen and the lack of which-way information is depicted. The single shutter is opened after the atom exists the micromaser cavity where it emitted a photon and before the atom reaches the double-slit screen. If repeated many times, the atomic distribution at the detection screen is the many narrow hump distribution characteristic of interference (no which-way information). One can decide whether to obtain “which-way” information or not to obtain such information (and show interference) until the atom passes through the double-slit screen.

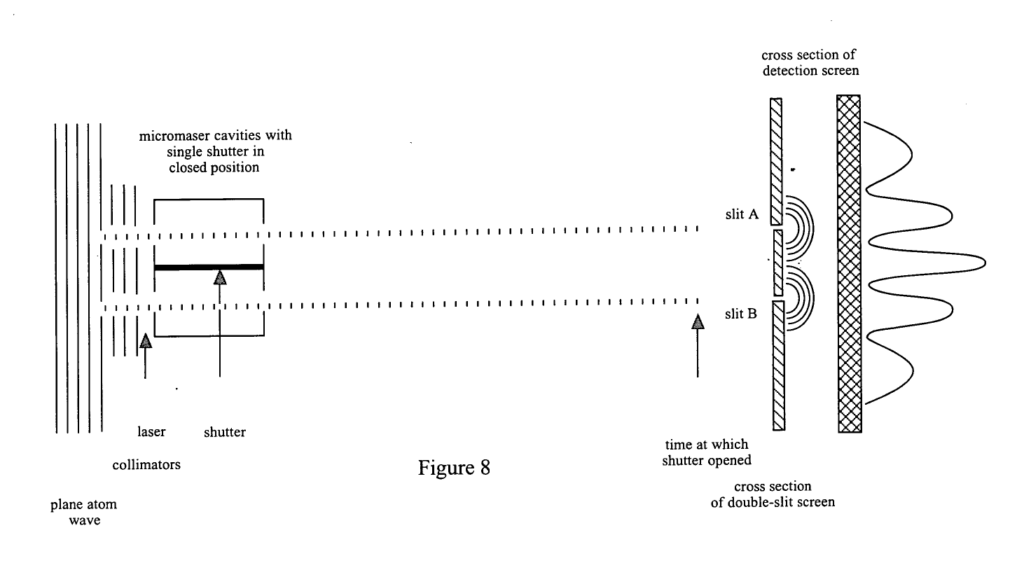

FIG. 9—Overview of basic features of the Quantum Information Transmission Device containing carrel with many paired micromaser cavity systems where the double-slit screen is placed near the detection screen. The carrel turns clockwise one position after each run is completed (i.e., a new set of paired micromaser cavities is set in place for a new run). After a set of paired micromaser cavities is rotated into place for a run, the shutter is left closed for the run. The distribution pattern of atoms at the detection screen is one broad hump pattern characteristic of which-way information. In the actual implementation, the carrel should contain at least 100 paired micromaser cavity systems needed to produce a recognizable distribution pattern.

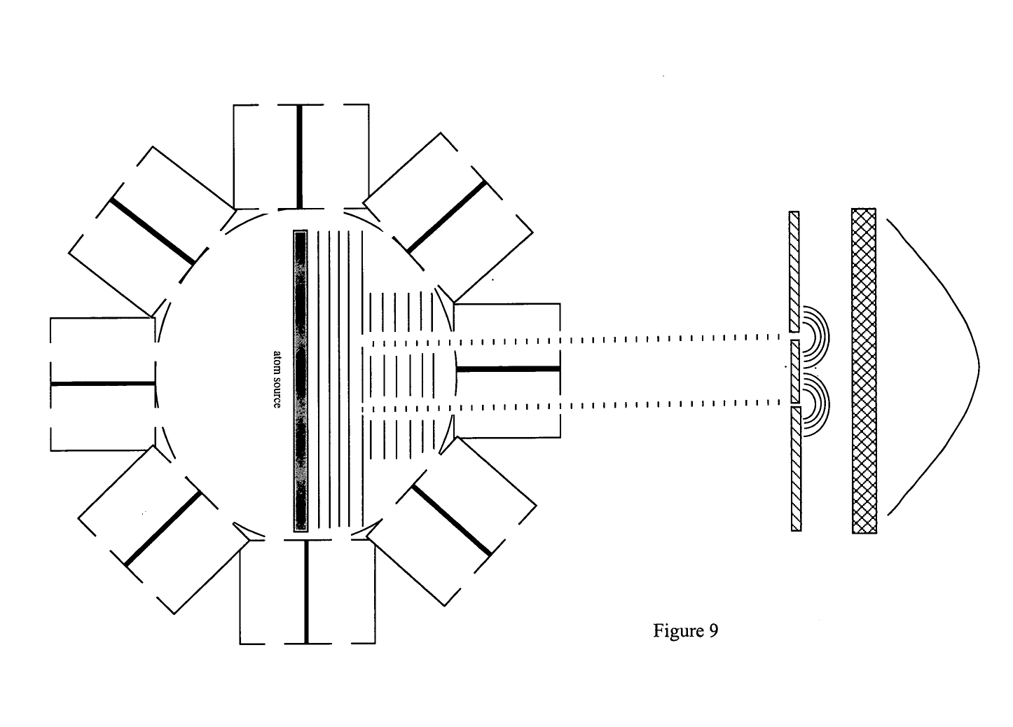

FIG. 10—Overview of basic features of Quantum Information Transmission Device with carrel containing many paired micromaser cavity systems where the double-slit screen is placed near the detection screen. The carrel turns clockwise one position after each run is completed (i.e., a new set of paired micromaser cavities is set in place for a new run). The shutter between the paired micromaser cavities set in place for a new run is opened after the atom leaves the micromaser cavity system and before the atom reaches the double-slit screen. The distribution pattern of atoms at the detection screen is the many narrow hump pattern characteristic of interference (no which-way information). The carrel should contain at least 100 paired micromaser cavity systems needed to produce a recognizable distribution pattern.

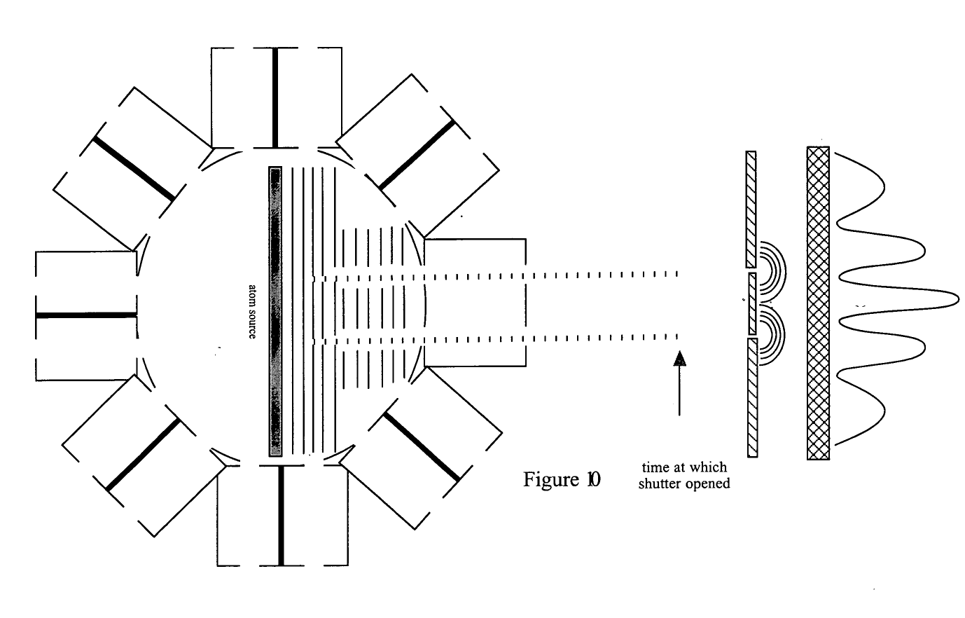

FIG. 11—Overview of set of three carrels displayed in FIGS. 8 and 9, each with many paired micromaser cavities systems where double-slit screen is placed near the detection screen. For two carrels, the shutter between the pair of micromaser cavities set in place for a run remains closed. The distribution pattern of atoms at the detection screen for each of these two carrels is the one broad hump pattern characteristic of which-way information. For one carrel (middle one), the shutter between the paired micromaser cavities set in place for a run is opened after the atom has exited the micromaser cavities system and before the atom reaches the double-slit screen. The distribution pattern of atoms at the detection screen for this carrel is the many narrow hump pattern characteristic of interference (no which-way information). A bit detector collects one bit from each carrel system, for example “0” for the one broad hump atomic distribution pattern and “1” for the many narrow hump atomic distribution pattern. A bit collector registers 0 1 0. One could also use paired micromaser cavities systems like in FIGS. 7 and 8, each pair used in runs in a serial fashion to develop bits of information.

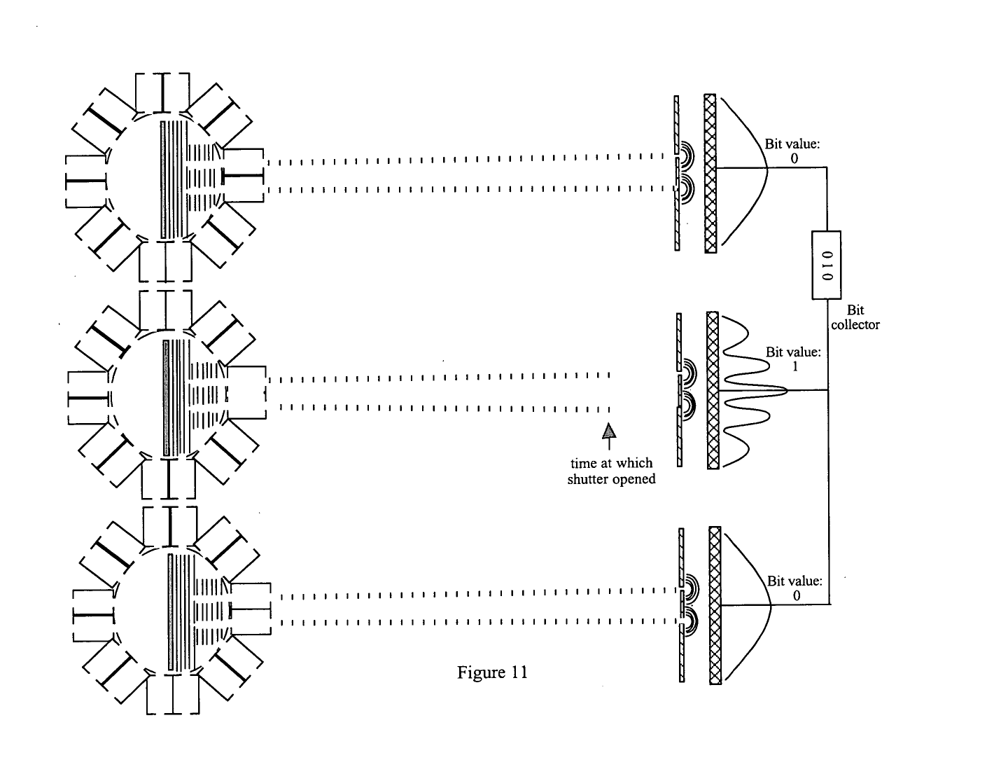

FIG. 12—The Optical Quantum Information Transfer Device (OQITD) with the shielding enclosure in closed position. With the shielding enclosure over the interferometer in closed position from creation of the signal-idler photon pair until after the idler photon passes through, or is reflected off, BS, which-way information is not made available to the environment while the idler photon travels through the interferometer and no longer can be after the idler photon passes through, or is reflected off, BS. Reflection off, or passage through, BS of the idler photon occurs before the paired signal photon reaches its detection axis. Over a set of runs in this format, the distribution of the paired signal photons manifests Young-like interference.

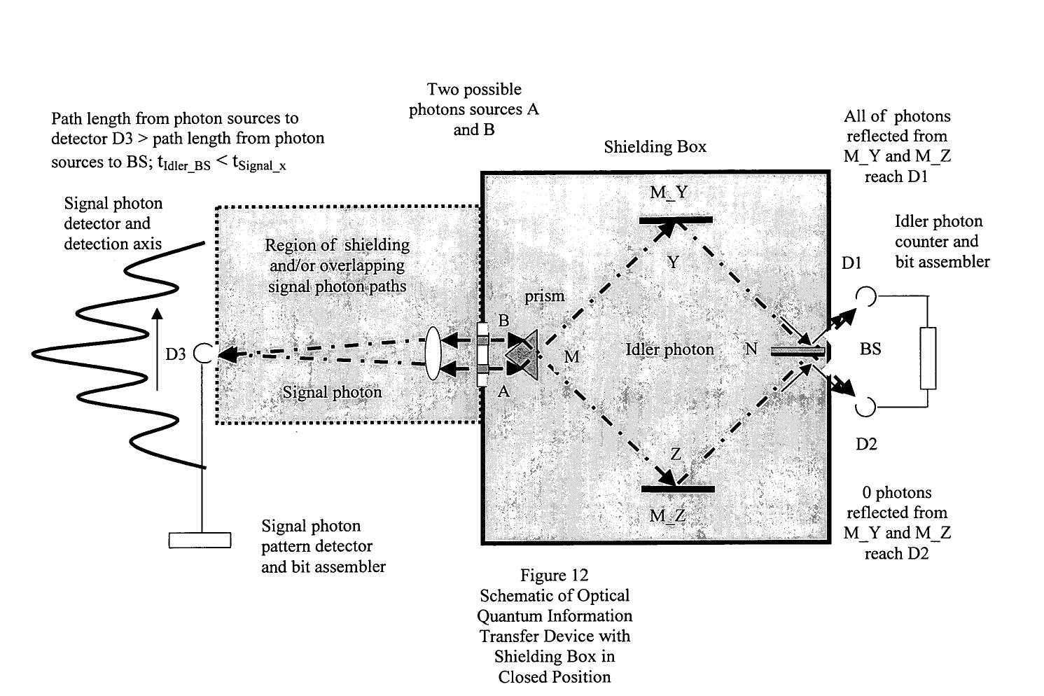

FIG. 13—The Optical Quantum Information Transfer Device with the shielding enclosure in open position. The shielding enclosure opened before idler photon reaches BS, making which-way information available to the environment. Reflection off, or passage through, BS of idler photon occurs before the paired signal photon reaches its detection axis. Over a set of runs in this format, the distribution of paired signal photons is characteristic of which-way information.

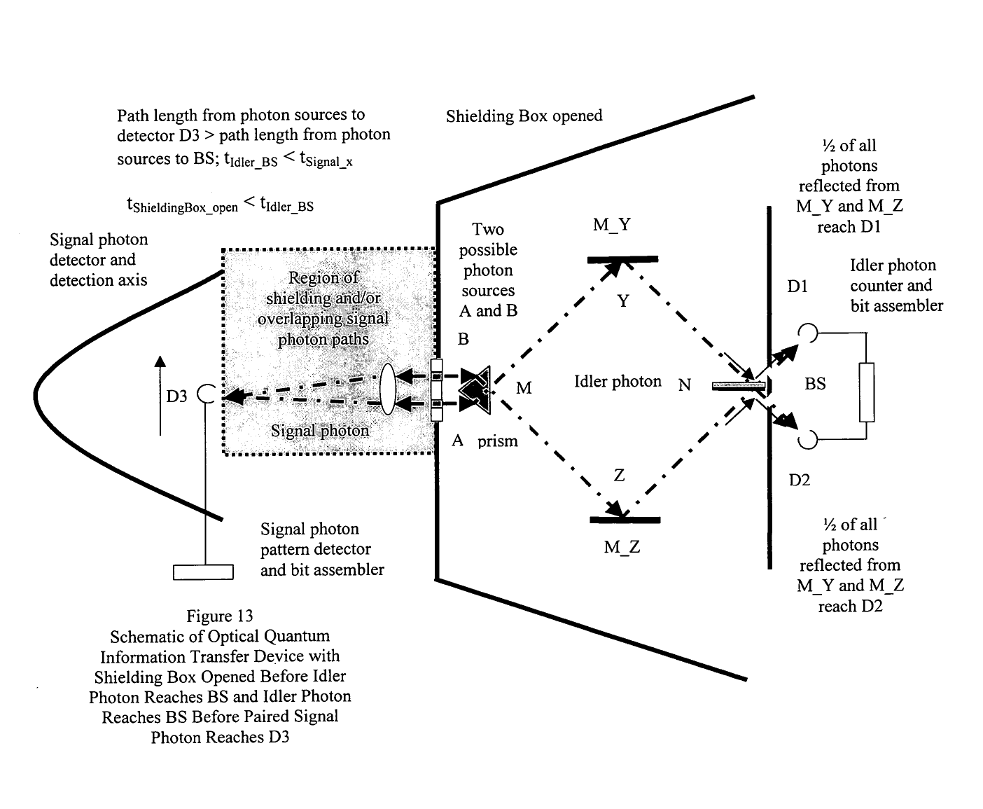

FIG. 14—A Mach-Zehnder interferometer demonstrating coherence of wave function components for photon traveling different routes from M to N with the result that constructive and destructive interference is exhibited at detectors D1 and D2, respectively.

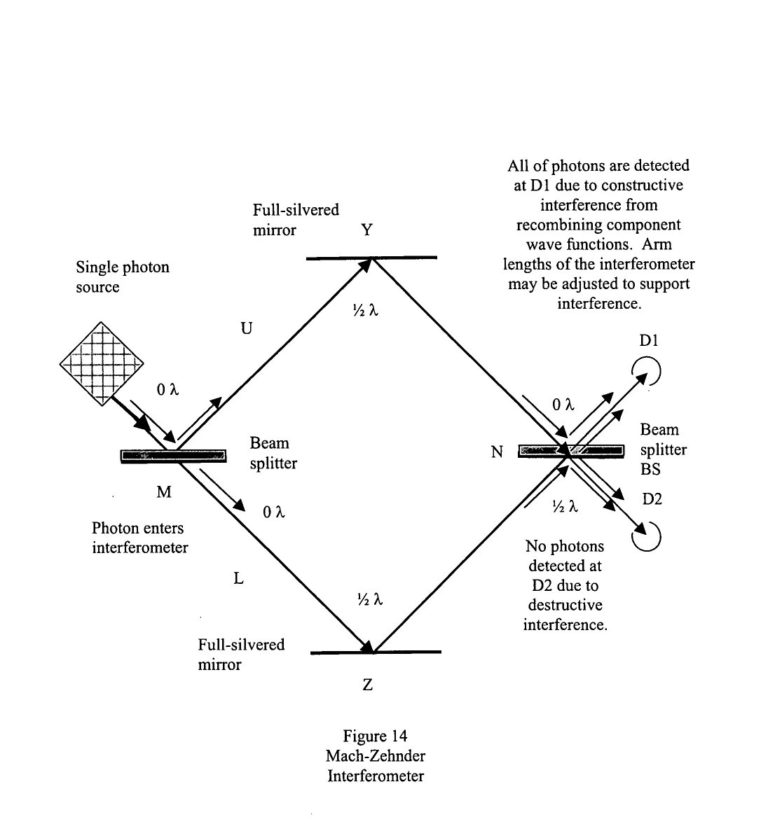

### DETAILED DESCRIPTION OF THE INVENTION

It is possible with the OQITD to transfer binary information, in part, without the limitation of the velocity of light in vacuum. The OQITD relies on “hidden” events for idler photons traveling through an interferometer where these “hidden” events point to which-way information for these photons. Through either: 1) keeping the “hidden” events “hidden” until which-way information is lost, or 2) instead making these events public before which-way information is lost, one can influence the overall spatial distribution of distant paired signal photons that were created in the same process and at the same location as the idler photons and which travel in a different direction than the idler photons. Which-path information concerning the signal photons themselves becomes unavailable after their creation with the overlap of the possible paths of the signal photons (and their being shielded by a separate enclosure before the paths overlap and possibly their being shielded by this enclosure over the entire distance from the possible locations of the creation of the signal-idler photon pairs to the signal photon detection axis where the signal photons are detected). Nonetheless, the signal photon remains entangled with the paired idler photon (except when the idler photon passes through or is reflected off, BS while the shielding enclosure remains closed) and thus reflects the status of the paired idler photon. Two possible overall distributions for the signal photons can be developed in different sets of runs of the OQITD. One distribution of the signal photons is indicative of which-way information concerning the idler photons with which they are paired, and the other distribution is indicative of interference concerning the idler photons with which the signal photons are paired. These two different distributions can be used to create binary bits which themselves can be assembled into a message. The motion of the paired signal and idler photons does not violate the velocity limitation of the special theory of relativity. Nonetheless, through 1) and 2) above, the effect of manipulating the circumstances concerning the idler photons on the distribution of the distant paired signal photons is not limited by the velocity limitation of the special theory. This effect is used to transmit a binary message. The invention consists of the following elements and operates in the following way:
1. An interferometer where there are two paths along which a photon (the idler photon) entering the interferometer can travel to a point where the paths intersect at a 50-50 beam splitter (BS) located with the following conditions: a) the paths of the interferometer have the same length from the point at which the photon enters the interferometer until the photon reaches the beam splitter BS which is where the two paths through the interferometer intersect at the exit of the interferometer; b) the components of the interferometer are designed to allow for phase coherence of wave function components of a photon as the photon travels through the interferometer, if more than one wave component exists; c) if coherence among wave function components occurs, interference is the result of the photon's interaction with the beam splitter and the effects of this interference are observed at the photon detectors located along extensions of the two paths of the interferometer that originate at the beam splitter BS (i.e., where these extensions-begin at the exit of the interferometer at BS); d) the path lengths from the beam splitter BS to the subsequent detectors are equal.
2. Two photodetectors with each one of them located along one of the exit paths for the photons interacting with the beam splitter BS described in claim 5.
3. Two possible photon sources situated in proximity to the entrance to the interferometer where photons (idler photons), traveling along their respective paths from their sources are refracted at a prism, or an equivalent instrument, that diverts an idler photon into one of the paths of the interferometer such that a photon from one of the two possible photon sources enters a specific interferometer path and a photon from the other possible photon source enters the other specific interferometer path (and there is no other distinction other than the photon source—interferometer path association that allows for distinguishing a photon traveling from its specific source to its entrance to a specific path of the interferometer from a photon that travels from the other specific source to its specific entrance to a specific path of the interferometer, including that the distance from one specific photon source to the entrance to a specific interferometer path associated with that source is equal to that distance from the other specific photon source to the entrance to the specific interferometer path associated with this other source).
4. The process described in claim 7 whereby a photon (i.e., an idler photon) is generated at one of the two photon sources which travels through the interferometer also generates another photon paired to the idler photon (i.e., a signal photon) that travels in another direction. A process such as spontaneous parametric down conversion (SPDC) is used to create the signal-idler photon pairs where the energy and momentum of each created signal and idler photon pair equals the energy and momentum of the original photon from which the signal and idler photon pair is created and where the apparatus used to create the signal-idler photon pair is thus left unchanged in the process of the creation of the signal-idler photon pair so that the functioning of the apparatus itself (i.e., a photon source) does not provide which-way information concerning the initial source of the signal-idler photon pair. In the specific use of SPDC in the OQITD, a pump laser beam is split with a double slit. The two resulting beams interact with a non-linear optical crystal. These two possible interaction areas in the non-linear optical crystal are the two possible sources of the signal-idler photon pair
5. The possible paths of the signal photon originating at the two possible photon sources come to overlap and this overlapping can be facilitated, for example, by the use of a lens near the two possible photon sources through which the two possible paths of the signal photon pass, where this lens produces the far field effect so that the possible photon paths overlap much closer to the possible photon sources than would be the case without it.
6. A detection device that can detect signal photons along an axis roughly perpendicular to the overlapping two possible paths of the signal photon.
7. The path lengths of the possible paths through the interferometer for the idler photons beginning at the two possible photon sources until the detectors for the idler photons situated after the beam splitter of the interferometer are equal, and the path lengths from the possible photon sources to the beam splitter BS are equal, this latter path length being less than the path length for the signal photon from either of the two possible photon sources to the signal photon detector (where the path lengths for the signal photon from both of the two possible photon sources to the signal photon detector are equal).
8. An enclosure that can shield the interferometer and the area anterior to the interferometer (i.e., from the two possible photon sources) until posterior to the beam splitter BS that is located at the exit of the interferometer such that:
   a. when the shielding enclosure is opened while the idler photon is traveling through the interferometer (before the idler photon reaches BS), it allows the potential which-path information concerning the source of the idler photon passing through the interferometer to be available to the environment and the specific photon source can be subsequently determined by measuring the specific path the idler photon travels through the interferometer, or
   b. when the enclosure remains closed until after the idler photon passes through or is reflected at BS, the enclosure acts effectively as a shield not allowing potential which-path information concerning the source of the idler photon passing through the interferometer to be available to the environment.
9. The possible paths of the signal photon being shielded by a separate enclosure (other than that described in 8) from the two possible signal-idler photon sources until at least these possible paths overlap so that the possible paths become indistinguishable from one another and do not provide general which-way information concerning the signal photon itself to the environment (i.e., this shielding enclosure preventing potential which-way information concerning the signal photon itself being made available to the environment with the result that a measurement of the specific path of the signal photon cannot be made) and where the entire length of the possible paths of the signal photons from creation at the possible signal-idler photon sources to the detector axis may need to be so shielded.
10. An idler photon counter that tallies the number of idler photons detected at each of the photodetectors, on the exit paths from the interferometer, over a set of runs of idler photons through the interferometer where throughout the runs of the set either:
   a. the shielding enclosure for the idler photon is opened on each run of a particular set while: a) the idler photon is passing through the interferometer, b) before the idler photon reaches BS, and c) the signal photon does not reach the signal detection axis until after the idler photon is reflected from or travels through BS, resulting in one distinct pattern of detections concerning the idler photons in the set (½ of the idler photons are detected at each of the idler photon detectors), or
   b. the shielding enclosure for the idler photon remains closed on each run of a particular set and the paired signal photon does not reach the signal photon detection axis before the idler photon reaches BS, with the result that a different distinct pattern of detections of the idler photons in the set to that noted in 10.a is recorded at the idler photon detectors (all of the idler photons are detected at one of the idler photon detectors and none of the idler photons at the other idler photon detector).
11. A bit assembler that assembles data, obtained by a photon counter that counts the number of idler photon detections at each of the two possible detectors in a set of runs of the OQITD, from each set of runs of the OQITD, where:
   a. the bit assembler associates a “0” with the distribution of idler photons in a set of runs noted in 10.a. (½ of the idler photons are detected at each of the idler photon detectors), that occurs if the shielding enclosure for the idler photon is opened on each run of a particular set while: a) the idler photon is passing through the interferometer, b) before the idler photon reaches BS, and c) the signal photon does not reach the signal photon detection axis until after the idler photon is reflected from or travels through BS.
   b. the bit assembler associates a “1” with the distribution of idler photons in a set of runs noted in 10.b. (all of the idler photons are detected at one of the idler photon detectors and none at the other idler photon detector), where the shielding enclosure for the idler photon remains closed on each run of a particular set and the paired signal photon does not reach the signal photon detection axis before the idler photon reaches BS.
The bit assembler assembles the bits as they develop over sets of runs, where each of the two possible distinct patterns of detections of the idler photons at the idler photon detectors is associated with a different binary bit value (and the association of a specific distinct pattern of detections of the idler photons at the idler photon detectors and a specific binary bit value has been noted).
12. A signal photon pattern detector that determines whether the distribution pattern of signal photons in a set of runs (of at least 100 runs) is the one wide hump pattern characteristic of the general availability of which-way information (concerning the idler photons) or instead is the many narrow hills pattern characteristic of interference (concerning the idler photons) where each set of runs of the OQITD is conducted either where:
   a. the shielding enclosure for the idler photon is opened on each run of a particular set while: a) the idler photon is passing through the interferometer, b) before the idler photon reaches BS, and c) the signal photon does not reach the signal photon detection axis until after the idler photon is reflected from or travels through BS, and a distinct pattern of detections of the idler photons in the set is recorded at the idler photon detectors described in 10.a. and 11.a. and the overall distribution of the paired signal photons is the one wide hump pattern characteristic of which-way information that reflects the presence of which-way information for the idler photons, or
   b. the shielding enclosure for the idler photons remains closed on each run of a particular set and the paired signal photon does not reach the signal photon detection axis before the idler photon reaches BS, resulting in the distinct pattern of detections concerning the idler photons in the set described in 10.b. and 11.b. at the idler photon detectors and the overall distribution of paired signal photons is the many narrow hills pattern characteristic of interference that reflects the presence of interference for the idler photons.
13. A signal photon bit assembler that collects the results obtained in different sets of runs by the signal photon pattern detector and translates them into a sequence of binary digits, with:
   a. a “0” associated with one of the two possible overall distributions of the signal photons (i.e., found in a set where the shielding enclosure over the interferometer is opened in each run before the idler photon reaches BS, before the paired signal photon reaches the signal photon detection axis, and where the signal photon does not reach the signal photon detection axis until after the idler photon is reflected from or travels through BS) in one set of runs of the OQITD, and this distribution is the one wide hump pattern characteristic of which-way information for the paired signal photons that reflects the presence of which-way information for the idler photons, or
   b. a “1” associated with the other possible distribution of the signal photons (e.g., found in a set where the shielding enclosure over the interferometer is left closed throughout each run and the idler photon reaches BS before the paired signal photon reaches the signal photon detection axis) in one set of runs of the OQITD and the distribution is the many narrow hills pattern characteristic of interference for the paired signal photons that reflects the presence of interference for the idler photons.

1. I claim a device using paired photons (e.g., for example signal and idler photons created in a process such as spontaneous parametric down conversion) that can send binary information between locations remote from one another and where at least part of the information can be transmitted without the velocity limitation of the velocity of light in vacuum.

2. I claim the device noted in claim 1 relies on “hidden” or shielded events (events not available to the environment) for at least one of the photons of a pair (e.g., the idler photon) traveling through an interferometer where these “hidden” events point to which-way information for the photon traveling through the interferometer.

3. I claim the device noted in claim 1 and further described in claim 2 operates through either: 1) keeping the “hidden” events concerning the idler photons passing through the interferometer “hidden” until potential which-way information concerning the idler photons is lost, or 2) instead making these events public before potential which-way information is lost, and that through the use of options 1 and 2 involving the interferometer in conjunction with some other constraints one can influence the overall spatial distribution of distant paired signal photons that were created in the same process and at the same location as the idler photons and that travel in a different direction than the idler photons.

4. I claim that the device noted in claim 1 and further described in claims 2 and 3 uses two different overall distributions of the paired signal photons (one distribution reflecting the adoption of option 1 in claim 3 and the other distribution reflecting the adoption of option 2 in claim 3) to create binary bits with value “0” or “1” and these bits themselves can be assembled into a message at the location of the distribution of paired signal photons where this message originated in the exercise of options 1 and 2 concerning the idler photons.

5. I claim the device described in claims 1, 2, 3, and 4 includes an interferometer where there are two paths along which a photon (the idler photon) entering the interferometer can travel to a point where the paths intersect at a 50-50 beam splitter (BS) located with the following conditions: a) the paths of the interferometer have the same length from the point at which the photon enters the interferometer until the photon reaches the beam splitter BS which is where the two paths through the interferometer intersect at the exit of the interferometer; b) the components of the interferometer are designed to allow for phase coherence of wave function components of a photon as the photon travels through the interferometer, if more than one wave component exists; c) if coherence among wave function components occurs, interference is the result of the photon's interaction with the beam splitter and the effects of this interference are observed at the photon detectors located along extensions of the two paths of the interferometer that originate at the beam splitter BS (i.e., where these extensions begin at the exit of the interferometer at BS); d) the path lengths from the beam splitter BS to the subsequent detectors are equal.

6. I claim the device described in claims 1, 2, 3, and 4 is further comprised of two photodetectors with each one of them located along one of the exit paths for the photons interacting with the beam splitter BS described in claim 5.

7. I claim the device described in claims 1, 2, 3, and 4 is further comprised of two possible photon sources situated in proximity to the entrance to the interferometer where photons (idler photons), traveling along their respective paths from their sources are refracted at a prism, or an equivalent instrument, that diverts an idler photon into one of the paths of the interferometer such that a photon from one of the two possible photon sources enters a specific interferometer path and a photon from the other possible photon source enters the other specific interferometer path (and there is no other distinction other than the photon source—interferometer path association that allows for distinguishing a photon traveling from its specific source to its entrance to a specific path of the interferometer from a photon that travels from the other specific source to its specific entrance to a specific path of the interferometer, including that the distance from one specific photon source to the entrance to a specific interferometer path associated with that source is equal to that distance from the other specific photon source to the entrance to the specific interferometer path associated with this other source).

8. I claim the device described in claims 1, 2, 3, and 4 is further characterized by the process described in claim 7 whereby a photon (i.e., an idler photon) is generated at one of the two photon sources which travels through the interferometer also generates another photon paired to the idler photon (i.e., a signal photon) that travels in another direction.

9. I claim the two possible photon sources described in claims 7 and 8 rely on a process such as spontaneous parametric down conversion (SPDC) to create the signal-idler photon pairs where the energy and momentum of each created signal and idler photon pair equals the energy and momentum of the original photon from which the signal and idler photon pair is created and where the apparatus used to create the signal-idler photon pair is thus left unchanged in the process of the creation of the signal-idler photon pair so that the functioning of the photon source itself does not provide which-way information concerning the initial source of the signal-idler photon pair.

10. I claim the process described in claim 8 is one where the possible paths of the signal photon originating at the two possible photon sources come to overlap and this overlapping can be facilitated, for example, by the use of a lens near the two possible photon sources through which the two possible paths of the signal photon pass, where this lens produces the far field effect so that the possible photon paths overlap much closer to the possible photon sources than would be the case without it.

11. I claim the device described in claims 1, 2, 3, and 4 is further comprised of a detection device that can detect signal photons along an axis roughly perpendicular to the overlapping two possible paths of the signal photon.

12. I claim the device described in claims 1, 2, 3, and 4 is further characterized by the path lengths of the possible paths through the interferometer for the idler photons beginning at the two possible photon sources until the detectors for the idler photons situated after the beam splitter of the interferometer are equal, and the path lengths from the possible photon sources to the beam splitter BS are equal, this latter path length being less than the path length for the signal photon from either of the two possible photon sources to the signal photon detector (where the path lengths for the signal photon from both of the two possible photon sources to the signal photon detector are equal).

13. I claim the device described in claims 1, 2, 3, and 4 is further characterized by an enclosure that can shield the interferometer and the area anterior to the interferometer (i.e., from the two possible photon sources) until posterior to the beam splitter BS that is located at the exit of the interferometer such that:
a. when the shielding enclosure is opened while the idler photon is traveling through the interferometer (before the idler photon reaches BS), it allows the potential which-path information concerning the source of the idler photon passing through the interferometer to be available to the environment and the specific photon source can be subsequently determined by measuring the specific path the idler photon travels through the interferometer, or
b. when the enclosure remains closed until after the idler photon passes through or is reflected at BS, the enclosure acts effectively as a shield not allowing potential which-path information concerning the source of the idler photon passing through the interferometer to be available to the environment.

14. I claim the device described in claims 1, 2, 3, and 4 is further characterized by the possible paths of the signal photon being shielded by a separate enclosure (other than that described in claim 13) from the two possible signal-idler photon sources until at least these possible paths overlap so that the possible paths become indistinguishable from one another and do not provide general which-way information concerning the signal photon itself to the environment (i.e., this shielding enclosure preventing potential which-way information concerning the signal photon itself being made available to the environment with the result that a measurement of the specific path of the signal photon cannot be made) and where the entire length of the possible paths of the signal photons from creation at the possible signal-idler photon sources to the detector axis may need to be so shielded.

15. I claim the device described in claims 1, 2, 3, and 4 is further comprised of an idler photon counter that tallies the number of idler photons detected at each of the photodetectors, on the exit paths from the interferometer, over a set of runs of idler photons through the interferometer where throughout the runs of the set either:
a. the shielding enclosure for the idler photon is opened on each run of a particular set while: a) the idler photon is passing through the interferometer, b) before the idler photon reaches BS, and c) the signal photon does not reach the signal detection axis until after the idler photon is reflected from or travels through BS, resulting in one distinct pattern of detections concerning the idler photons in the set (½ of the idler photons are detected at each of the idler photon detectors), or
b. the shielding enclosure for the idler photon remains closed on each run of a particular set and the paired signal photon does not reach the signal photon detection axis before the idler photon reaches BS, with the result that a different distinct pattern of detections of the idler photons in the set to that noted in 15.a is recorded at the idler photon detectors (all of the idler photons are detected at one of the idler photon detectors and none of the idler photons are detected at the other idler photon detector).

16. I claim the device described in claims 1, 2, 3, and 4 is further comprised of a bit assembler that assembles data, obtained by a photon counter that counts the number of idler photon detections at each of the two possible detectors in a set of runs of the OQITD, from each set of runs of the OQITD, where:
a. the bit assembler associates a “0” with the distribution of idler photons in a set of runs noted in 15.a. (½ of the idler photons are detected at each of the idler photon detectors), that occurs if the shielding enclosure for the idler photon is opened on each run of a particular set while: a) the idler photon is passing through the interferometer, b) before the idler photon reaches BS, and c) the signal photon does not reach the signal photon detection axis until after the idler photon is reflected from or travels through BS.
b. the bit assembler associates a “1” with the distribution of idler photons in a set of runs noted in 15.b. (all of the idler photons are detected at one of the idler photon detectors and none at the other idler photon detector), where the shielding enclosure for the idler photon remains closed on each run of a particular set and the paired signal photon does not reach the signal photon detection axis before the idler photon reaches BS.

17. I claim that the bit assembler for the idler photons described in claim 16 assembles the bits as they develop over sets of runs, where each of the two possible distinct patterns of detections of the idler photons at the idler photon detectors is associated with a different binary bit value (and the association of a specific distinct pattern of detections of the idler photons at the idler photon detectors and a specific binary bit value is noted in claim 16).

18. I claim the device described in claims 1, 2, 3, and 4 is further comprised of a signal photon pattern detector that determines whether the distribution pattern of signal photons in a set of runs (of at least 100 runs) is the one wide hump pattern characteristic of the general availability of which-way information (concerning the idler photons) or instead is the many narrow hills pattern characteristic of interference (concerning the idler photons) where each set of runs of the OQITD is conducted either where:
a. the shielding enclosure for the idler photon is opened on each run of a particular set while: a) the idler photon is passing through the interferometer, b) before the idler photon reaches BS, and c) the signal photon does not reach the signal photon detection axis until after the idler photon is reflected from or travels through BS, and a distinct pattern of detections of the idler photons in the set is recorded at the idler photon detectors described in 15.a and 16.a and the overall distribution of paired signal photons is the one wide hump pattern characteristic of which-way information that reflects the presence of which-way information for the idler photons, or
b. the shielding enclosure for the idler photons remains closed on each run of a particular set and the paired signal photon does not reach the signal photon detection axis before the idler photon reaches BS, resulting in the distinct pattern of detections concerning the idler photons in the set described in 15.b and 16.b at the idler photon detectors and the overall distribution of paired signal photons is the many narrow hills pattern characteristic of interference that reflects the presence of interference for the idler photons.

19. I claim the device described in claims 1, 2, 3, and 4 is further comprised of a signal photon bit assembler that collects the results obtained in different sets of runs by the signal photon pattern detector and translates them into a sequence of binary digits, with:
a. a “0” associated with one of the two possible overall distributions of the signal photons (i.e., found in a set where the shielding enclosure over the interferometer is opened in each run before the idler photon reaches BS, before the paired signal photon reaches the signal photon detection axis, and where the signal photon does not reach the signal photon detection axis until after the idler photon is reflected from or travels through BS) in one set of runs of the OQITD, and this distribution is the one wide hump pattern characteristic of which-way information for the paired signal photons that reflects the presence of which-way information for the idler photons, or
b. a “1” associated with the other possible overall distribution of the signal photons (i.e., found in a set where the shielding enclosure over the interferometer is left closed throughout each run and the idler photon reaches BS before the paired signal photon reaches the signal photon detection axis) in one set of runs of the OQITD and the distribution is the many narrow hills pattern characteristic of interference for the paired signal photons that reflects the presence of interference for the idler photons.
